(19) United States
(12) Patent Application Publication
(10) Pub. No.: US 2005/0079361 A1
(43) Pub. Date: Apr. 14, 2005

(54) Materials useful in making cellulosic acquisition fibers in sheet form

(76) Inventors: Othman A. Hamed, Jesup, GA (US); Harry J. Chmielewski, Brunswick, GA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/683,164

(22) Filed: Oct. 14, 2003

(51) Int. Cl. D21F 11/00; B32B 27/38

(52) U.S. Cl. 428/413; 162/135; 162/158; 162/184; 604/374

(57) ABSTRACT

Embodiments of the invention relate to a modifying agent for making cellulosic based acquisition fibers in the sheet form, the modifying agent being the reaction product of a polycarboxylic acid compound and a polyfunctional epoxy compound. A method of producing the cellulosic based acquisition fiber in the sheet from using the modifying agent includes treating the cellulosic fibers in the sheet form with the modifying agent, and drying and curing the treated sheet to promote the formation of intra-fiber bonding. The resultant cellulosic based acquisition fiber may be utilized in an acquisition layer and/or an absorbent core of an absorbent article.

### BACKGROUND OF THE INVENTION

1. Field of the Invention

Embodiments of the present invention relate to a modifying agent for making cellulosic based acquisition fiber in sheet form and to a process for making the modifying agent. The modifying agent can be made by reacting a polyfunctional epoxy compound and a polycarboxylic acid compound. Embodiments of the present invention also relate to methods of making the cellulosic based acquisition fiber in the sheet form using the inventive modifying agent. The hydrophobic cellulosic fibers of the present invention can be characterized as having an improved centrifuge retention capacity, acquisition rate, resiliency, bulk and absorbency under load. The fibers are especially suited for use in absorbent articles intended for body fluid management.

2. Description of Related Art

Absorbent articles intended for personal care, such as adult incontinent pads, feminine care products, and infant diapers typically are comprised of at least a top sheet, a back sheet, an absorbent core disposed between the top sheet and back sheet, and an optional acquisition layer disposed between the top sheet and the absorbent core. The acquisition layer comprised of, for example, acquisition fibers, usually is incorporated in the absorbent articles to provide better distribution of liquid, increased rate of liquid absorption, reduced gel blocking, and improved surface dryness. A wide variety of acquisition fibers are known in the art. Included among these are synthetic fibers, a composite of cellulosic fibers and synthetic fibers, and cross-linked cellulosic fibers. Cross-linked cellulosic fiber is preferred because it is abundant, it is biodegradable, and it is relatively inexpensive.

Cross-linked cellulosic fibers and processes for making them have been described in the literature for many years (see, for example G. C. Tesoro, Cross-Linking of Cellulosics, in Handbook of Fiber Science and Technology, Vol. II, M. Lewis and S. B. Sello eds. pp 1-46, Mercell Decker, New York (1993)). The cross-linked cellulosic fibers typically are prepared by reacting cellulose with polyfunctional agents that are capable of reacting with the hydroxyl groups of the anhydroglucose repeating units of the cellulose either in the same chain, or in neighboring chains simultaneously.

Cellulosic fibers typically are cross-linked in fluff form. Processes for making cross-linked fiber in the fluff form comprise dipping swollen or non-swollen fiber in an aqueous solution of cross-linking agent, catalyst, and softener. The fiber so treated, usually is then cross-linked by heating it at elevated temperature in the swollen state as described in U.S. Pat. No. 3,241,553, or in the collapsed state after defiberizing it as described in U.S. Pat. No. 3,224,926, and European Patent No. 0,427,361 B1, the disclosures of each of which are incorporated by reference herein in their entirety.

Cross-linking of fibers is believed to improve the physical and the chemical properties of fibers in many ways, such as improving the resiliency (in the dry and wet state), increasing the absorbency, reducing wrinkling, and improving shrinkage resistance. However, cross-linked cellulosic fibers have not been widely adopted in absorbent products, seemingly because of the difficulty of successfully cross-linking cellulosic fibers in the sheet form. More specifically, it has been found that cross-linked fiber in the sheet form tends to become difficult to defiberize without causing substantial problems with the fibers. These problems include severe fiber breakage and increased amounts of knots and nits (hard fiber clumps). These disadvantages render the cross-linked product completely unsuitable for many applications.

These problems are believed to be attributable to two factors: (a) sheeted fibers in a dry state are in intimate contact with each other; and (b) the presence of pulping and bleaching residuals such as lignin and hemicellulose. Mechanical entanglement and hydrogen bonding of the sheeted fibers brings fibers into close contact. As a result, when fibers are treated with a cross-linking agent and are heated for curing, the fibers tend to form inter-fiber cross-links (between two adjacent fibers) rather than intra-fiber cross-links (chain to chain within a single fiber). Pulping and bleaching residuals such as lignin and hemicellulose, combine with the cross-linking agents under the heated conditions of the cross-linking reaction to form thermosetting adhesives. Thus, these residuals serve to adhesively bond adjacent fibers so that it is very difficult to separate them under any conditions without considerable fiber breakage. Because the cross-linked fibers tend to be brittle, the fibers themselves will often break, leaving the bonded areas between adjacent fibers intact.

There have been many proposed solutions to overcome some of the problems of cross-linking fiber in sheet form. One alleged solution to this problem is to minimize the contact between fibers in the dry state. For example, Graef et al. in U.S. Pat. No. 5,399,240, the disclosure of which is incorporated herein by reference in its entirety, describes a method of treating fiber in the sheet form with a cross-linking agent and a de-bonder. Fiber while in the sheet form is then cured at elevated temperatures. The de-bonder tends to interfere with the hydrogen bonding between fibers and thus minimizes the contact between fibers. As a result, fibers are produced with a relatively low content of knots and nits. Unfortunately, the long hydrophobic alkane chain tends to have undesirable hydrophobic effects on fibers, e.g., resulting in decreased absorbency and wettability, rendering it unsuitable for applications such as in absorbent articles, where a high rate of absorbency and fast acquisition are required.

In U.S. Pat. No. 3,434,918, Bernardin et al. disclose a method of treating fibers in sheet form with a cross-linking agent and a catalyst. The treated sheet then is wet-aged to render the cross-linking agent insoluble. The wet-aged fibers are re-dispersed before curing, mixed with untreated fibers, sheeted and then cured. The mixture of cross-linked fibers and untreated fibers are potentially useful for making products such as filter media, tissues, and toweling where high bulk and good water absorbency are desired without excessive stiffness in the product. Unfortunately, the presence of untreated fibers make the produced fiber unsuitable as an acquisition layer in hygiene products such as diapers.

Other documents describing methods of treating fiber in sheet form include, for example, U.S. Pat. Nos. 4,204,054; 3,844,880; and 3,700,549 (the disclosures of each of which are incorporated by reference herein in their entirety). However, the above-described approaches complicate the process of cross-linking fiber in sheet form, and render the process time consuming, and costly. As a result, these processes result in cross-linked fibers with a substantial decrease in fiber performance, and a substantial increase in cost.

In previous work (U.S. patent application Ser. No. 10/166,254, entitled: “Chemically Cross-Linked Cellulosic Fiber and Method of Making the Same,” filed on Jun. 11, 2002, and Ser. No. 09/832,634, entitled “Cross-Linked Pulp and Method of Making Same,” filed Apr. 10, 2001, and U.S. Application entitled “Method For Making Chemically Cross-Linked Cellulosic Fiber In The Sheet Form,” filed Mar. 14, 2003, attorney docket number 60892.000005) it was shown that mercerized fiber and a mixture of mercerized and conventional fibers can be successfully cross-linked in sheet form. The produced cross-linked fiber showed similar or better performance characteristics than conventional individualized cross-linked cellulose fibers. Also, the produced fiber showed less discoloration and reduced amounts of knots and nits compared to conventional individualized cross-linked fiber.

Fiber mercerization, which is a treatment of fiber with an aqueous solution of sodium hydroxide (caustic), is one of the earliest known modifications of fiber. It was invented 150 years ago by John Mercer (see British Patent 1369, 1850). The process generally is used in the textile industry to improve cotton fabric's tensile strength, dyeability, and luster (see, for example, R. Freytag, J.-J. Donze, Chemical Processing of Fibers and Fabrics, Fundamental and Applications, Part A, in Handbook of Fiber Science and Technology Vol. I M. Lewis and S. B. Sello eds. pp. 1-46, Mercell Decker, New York (1983)).

The description herein of certain advantages and disadvantages of known acquisition cellulosic fibers, and methods of their preparation, is not intended to limit the scope of the present invention. Indeed, the present invention may include some or all of the methods and chemical reagents described above without suffering from the same disadvantages.

### SUMMARY OF THE INVENTION

In view of the difficulties presented by cross-linking cellulosic fibers in the sheet form, there is a need for a simple, relatively inexpensive, modifying agent suitable for making acquisition fibers in the sheet form without sacrificing wettability of the fibers, whereby the resultant sheet can be defiberized into individual fibers without serious fiber breakage. The resultant fiber sheet also preferably has low contents of knots and nits.

There exists a need for a process of making acquisition fibers in the sheet form that provides time and cost savings to both the acquisition fibers manufacturer and the manufacturer of absorbent articles. The present invention desires to fulfill these needs and to provide further related advantages.

It is therefore a feature of an embodiment of the invention to provide a modifying agent with hydrophobic characteristics to be used in preparing cellulosic based acquisition fiber in the sheet form. It also is a feature of an embodiment of the present invention to provide a method of making the cellulosic based acquisition fiber in the sheet form using the modifying agent of the present invention. It is yet another feature of an embodiment of the present invention to provide cellulosic based acquisition fiber in sheet form that has improved retention, absorption capacity, absorbency under load, and dry bulk. It is yet another feature of an embodiment of the present invention to provide a cellulosic based acquisition fiber in sheet form with reduced knots and nits, and fine contents. In yet another feature of an embodiment of the present invention, the acquisition fibers may be utilized as an acquisition layer or in the absorbent core of an absorbent article.

In accordance with these and other features of embodiments of the invention, there is provided a modifying agent useful in preparing cellulosic based acquisition fibers in the sheet form that is the reaction product of a polycarboxylic acid compound and a polyfunctional epoxy compound, preferably in a mole ratio of polycarboxylic acid to polyfunctional epoxy of about 2:1 to about 3:1. The polycarboxylic acid preferably comprises another functional group in addition to the carboxyl group, such as a hydroxyl group or an amino. The polyfunctional epoxy preferably comprises a substituent group, such as hydrogen or an alkyl group. The modifying agent may be provided in an aqueous solution, and may additionally comprise other materials, such as a catalyst or a surfactant.

In accordance with an additional feature of an embodiment of the present invention, there is provided a method of making cellulosic based acquisition fibers that includes applying a solution containing a modifying agent of the present invention to cellulosic fibers to impregnate the fibers, then drying and curing the impregnated cellulosic fibers. Another suitable method further provides impregnating cellulosic fibers in fluff form with the solution containing a modifying agent, drying the fibers at a temperature below curing temperature, defiberizing the fibers, and then curing them.

In accordance with another feature of an embodiment of the invention, there is provided a cellulosic based acquisition fibers produced by the method of the present invention, wherein the acquisition fibers have a centrifuge retention capacity of less than about 0.6 grams of a 0.9% by weight saline solution per gram of fiber (herein after “g/g”). The cellulosic based acquisition fibers also preferably have desirable properties such as an absorbent capacity of at least about 8.0 g/g, a dry bulk of at least about 8.0 cm³/g fiber, an absorbency under load greater than about 7.0 g/g, less than about 26% knots, and less than about 9% fines. These properties may be achieved singly, or in various combinations with one another.

In accordance with another feature of an embodiment of the invention, there is provided an absorbent article that utilizes the cellulosic based acquisition fibers of the present invention in an acquisition layer or absorbent structure.

These and other objects, features and advantages of the present invention will appear more fully from the following detailed description of the preferred embodiments of the invention, and the attached drawings.

### BRIEF DESCRIPTION OF THE DRAWINGS

The drawings show electron microscope photographs of representative cellulosic-based acquisition fibers of the present invention. The photographs were obtained using Scanning Electron Microscope S360 Leica Cambridge Ltd., Cambridge, England.

FIG. 1 is a photograph at 100× magnifications of untreated Rayfloc®-J-LD (southern pine Kraft pulp commercially available from Rayonier Performance Fibers Division, Jesup, Ga. and Fernandina Beach, Fla.).

FIG. 2 is a photograph at 200× magnifications of acquisition fiber obtained from a Pampers diaper product, which is produced by The Proctor & Gamble Company (“P&G”).

FIGS. 3A, 3B, and 3C are photographs at 100×, 400×, and 1000× magnifications, respectively of hydrophobic cellulosic fibers obtained as shown in example 5 from reacting Rayfloc®-J-LD fibers in sheet form with the modifying agent of the present invention.

FIGS. 4A, 4B, and 4C are photographs at 100×, 500×, and 1000× magnifications, respectively of cellulosic based acquisition fibers obtained as shown in example 11 from reacting Rayfloc®-J-LD fibers in fluff form with the modifying agent of the present invention.

FIG. 5 is a cross sectional photograph at 1000× magnifications of cellulosic based acquisition fibers obtained as shown in example 5 from reacting Rayfloc®-J-LD fibers in sheet form with the modifying agent of the present invention.

FIG. 6 shows gas chromatography chromatogram of a solution of 1,4-cyclohexanedimethanol diglycidyl ether in hexane.

FIG. 7 shows gas chromatography chromatograph of the extracts of the modifying agent made in accordance with the present invention as shown in Example 1.

FIG. 8 shows gas chromatography chromatograph of the extracts of the cellulosic based acquisition fibers made in accordance with the present invention as shown in Example 5.

### DETAILED DESCRIPTION OF THE PREFERRED EMBODIMENTS

The present invention is directed to cellulosic based acquisition fibers and to a method of making the fibers. The method comprises treating the cellulosic fibers in sheet, roll, or fluff form with a solution containing a modifying agent obtained by reacting a polycarboxylic acid compound and a polyfunctional polyexpoxy compound in aqueous medium.

As used herein, the terms “absorbent garment,” “absorbent article” or simply “article” or “garment” refer to mechanisms that absorb and contain body fluids and other body exudates. More specifically, these terms refer to garments that are placed against or in proximity to the body of a wearer to absorb and contain the various exudates discharged from the body. A non-exhaustive list of examples of absorbent garments includes diapers, diaper covers, disposable diapers, training pants, feminine hygiene products and adult incontinence products. Such garments may be intended to be discarded or partially discarded after a single use (“disposable” garments). Such garments may comprise essentially a single inseparable structure (“unitary” garments), or they may comprise replaceable inserts or other interchangeable parts.

Embodiments of the present invention may be used with all of the foregoing classes of absorbent garments, without limitation, whether disposable or otherwise. Some of the embodiments described herein provide, as an exemplary structure, a diaper for an infant, however this is not intended to limit the claimed invention. The invention will be understood to encompass, without limitation, all classes and types of absorbent garments, including those described herein.

The term “component” can refer, but is not limited, to designated selected regions, such as edges, corners, sides or the like; structural members, such as elastic strips, absorbent pads, stretchable layers or panels, layers of material, or the like.

Throughout this description, the term “disposed” and the expressions “disposed on,” “disposed above,” “disposed below,” “disposing on,” “disposed in,” “disposed between” and variations thereof are intended to mean that one element can be integral with another element, or that one element can be a separate structure bonded to or placed with or placed near another element. Thus, a component that is “disposed on” an element of the absorbent garment can be formed or applied directly or indirectly to a surface of the element, formed or applied between layers of a multiple layer element, formed or applied to a substrate that is placed with or near the element, formed or applied within a layer of the element or another substrate, or other variations or combinations thereof.

Throughout this description, the terms “top sheet” and “back sheet” denote the relationship of these materials or layers with respect to the absorbent core. It is understood that additional layers may be present between the absorbent core and the top sheet and back sheet, and that additional layers and other materials may be present on the side opposite the absorbent core from either the top sheet or the back sheet.

Throughout this description, the expressions “upper layer,” “lower layer,” “above” and “below,” which refer to the various components included in the absorbent material are used to describe the spatial relationship between the respective components. The upper layer or component “above” the other component need not always remain vertically above the core or component, and the lower layer or component “below” the other component need not always remain vertically below the core or component. Other configurations are contemplated within the context of the present invention.

Throughout this description, the term “impregnated” insofar as it relates to a modifying agent impregnated in a fiber, denotes an intimate mixture of modifying agents and cellulosic fibers, whereby the modifying agent may be adhered to the fibers, adsorbed on the surface of the fibers, or linked via chemical, hydrogen or other bonding (e.g., Van der Waals forces) to the fibers. Impregnated in the context of the present invention does not necessarily mean that the modifying agent is physically disposed beneath the surface of the fibers.

The present invention concerns cellulosic based acquisition fibers that are useful in absorbent articles, and in particular, that are useful in forming acquisition layers or absorbent cores in the absorbent article. The particular construction of the absorbent article is not critical to the present invention, and any absorbent article can benefit from this invention. Suitable absorbent garments are described, for example, in U.S. Pat. Nos. 5,281,207, and 6,068,620, the disclosures of each of which are incorporated by reference herein in their entirety including their respective drawings. Those skilled in the art will be capable of utilizing the acquisition fibers of the present invention in absorbent garments, cores, acquisition layers, and the like, using the guidelines provided herein.

In accordance with embodiments of the present invention, the modifying agents that are useful in making cellulosic acquisition fibers in the sheet form are made by reacting approximate stoichiometric quantities of a polycarboxylic acid compound and a polyfunctional epoxy compound.

Examples of suitable polycarboxylic acids are those having at least two carboxyl groups such as, for example, 1,2,3,4-butanetetracarboxylic acid, 1,2,3-propanetricarboxylic acid, oxydisuccinic acid, citric acid, itaconic acid, maleic acid, tartaric acid, glutaric acid, and iminodiacetic acid. Other suitable polycarboxylic acids include polymeric polycarboxylic acids such as, for example, those specially prepared from monomers such as acrylic acid, vinyl acetate, maleic acid, maleic anhydride, carboxy ethyl acrylate, itanoic acid, fumaric acid, methacrylic acid, crotonic acid, aconitic acid, acrylic acid ester, methacrylic acid ester, acrylic amide, and methacrylic amide, butadiene, styrene, or any combination thereof. Especially preferred polycarboxylic acids are alkane polycarboxylic acids having one or more hydroxyl groups such as citric acid and tartaric acid.

A polyfunctional epoxy that may be used in embodiments of the present invention preferably has the following general formula:

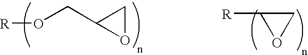

Wherein R is an alkyl with 3 or more carbon atoms; and n is an integer of from 1 to 4. The alkyl group includes saturated, unsaturated, substituted, un-substituted, branched and un-branched, cyclic, and acyclic compounds.

Typical examples of such polyfunctional epoxies include but are not limited to: 1,4-cyclohexanedimethanol diglycidyl ether, diglycidyl 1,2-cyclohexanedicarboxylate, diglycidyl 1,2,3,4-tetrahydrophthalate, glycerol propoxylate triglycidyl ether, 1,4-butanediol diglycidyl ether, neopentyldiglycidyl ether, polypropyleneglycol diglycidyl ether, or any combination thereof. Especially preferred polyfunctional epoxies are 1,4-cyclohexanedimethanol diglycidyl ether and neopentyldiglycidyl ether.

The modifying agent may be prepared by any suitable and convenient procedure. The polycarboxylic acid and polyfunctional epoxy are generally reacted in a mole ratio of polycarboxylic acid to polyfunctional epoxy of about 2.0:1 to about 3.0:1.0. The reaction may be carried out within the temperature range of room temperature up to reflux. Preferably the reaction is carried out at room temperature for about 6 hours, more preferably for about 10 hours and most preferably for about 16 hours. The product of the reaction is water-soluble, and can be diluted in water to any desirable concentration. In the case where 1,4-cyclohexanedimethanol diglycidyl ether is used as a polyfunctional epoxy the produced diluted solution is slightly cloudy, and the addition of surfactant clears up the solution. Suitable surfactants include nonionic, anionic, or cationic surfactants, or mixtures and combinations of surfactants that are compatible with each other. Preferably, the surfactant is selected from: Triton X-100 (Rohm and Haas), Triton X405 (Rohm and Haas), sodium lauryl sulfate, lauryl bromoethyl ammonium chloride, ethoxylated nonylphenols, and polyoxyethylene alkyl ethers. Preferably the surfactant is added in an amount less than 0.1 wt % based on the total weight of the solution.

Optionally, a catalyst may be added to the solution to accelerate the reaction between the polycarboxylic acid and the polyfunctional epoxy. Any catalyst known in the art to accelerate the formation of an ether bond or linkage between a hydroxyl group and an epoxide group is suitable for use in embodiments of the present invention. Preferably, the catalyst is a Lewis acid selected from aluminum sulfate, magnesium sulfate, and any Lewis acid that contains at least a metal and a halogen, including, for example FeCl₃, AlCl₃, and MgCl₂.

A representative structure of a modifying agent of an embodiment of the invention prepared by reacting citric acid with 1,4-cyclohexanedimethanol diglycidyl ether is shown in Scheme 1. Other possible reaction products formed in this reaction include but are not limited to those shown in Scheme 2. Fortunately, all of these side products can also react with the cellulosic fibers.

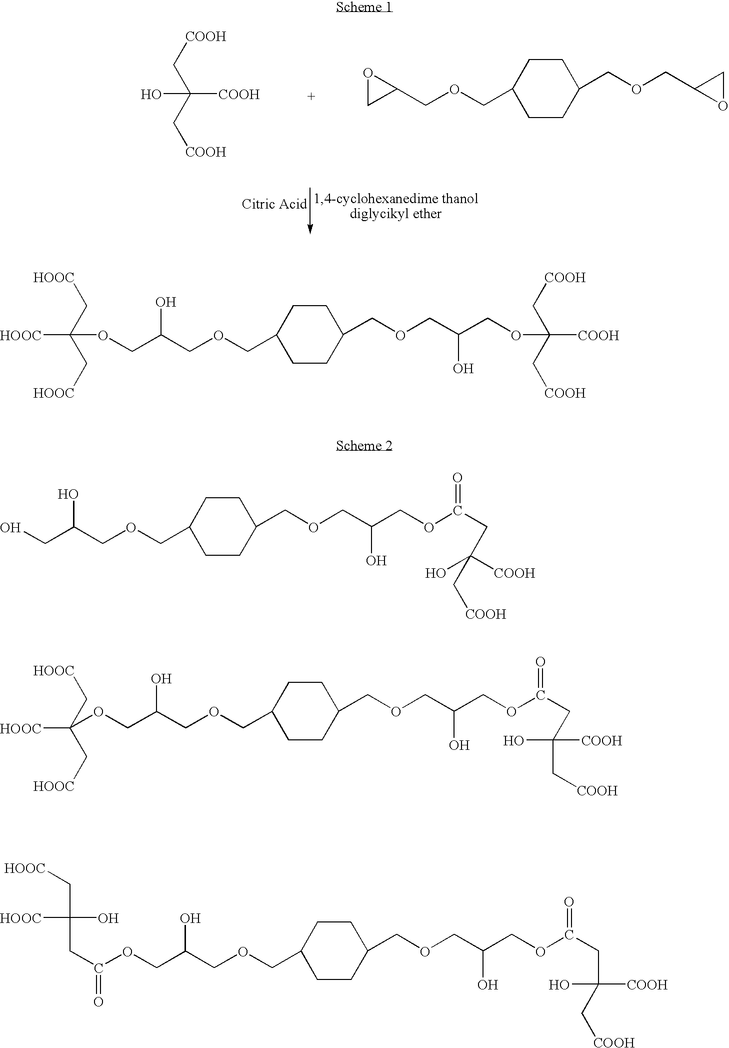

Another aspect of the present invention provides a method for making cellulosic based acquisition fibers using the modifying agents described above. The process preferably comprises treating cellulose fibers in sheet, roll or fluff form with an aqueous solution containing the modifying agent, followed by drying and curing at sufficient temperature and for a sufficient period of time to accelerate formation of covalent bonding between hydroxyl groups of cellulose fibers and functional groups of the modifying agent. Using the guidelines provided herein, those skilled in the art are capable of determining suitable drying and curing temperatures and times, depending on the reactants and the desired bonding density in the fibers.

Any cellulosic fibers can be used in the invention, so long as they provide the physical characteristics of the fibers described above. Suitable cellulosic fibers for use in forming the cellulosic based acquisition fibers of the present invention include those primarily derived from wood pulp. Suitable wood pulp can be obtained from any of the conventional chemical processes, such as the Kraft and sulfite processes. Preferred fibers are those obtained from various soft wood pulp such as Southern pine, White pine, Caribbean pine, Western hemlock, various spruces, (e.g. Sitka Spruce), Douglas fir or mixtures and combinations thereof. Fibers obtained from hardwood pulp sources, such as gum, maple, oak, eucalyptus, poplar, beech, and aspen, or mixtures and combinations thereof also can be used in the present invention. Other cellulosic fibers derived form cotton linter, bagasse, kemp, flax, and grass also may be used in the present invention. The fibers can be comprised of a mixture of two or more of the foregoing cellulose pulp products. Particularly preferred fibers for use in forming the cellulosic-based acquisition fibers of the present invention are those derived from wood pulp prepared by the Kraft and sulfite-pulping processes.

The cellulosic fibers can be derived from fibers in any of a variety of forms. For example, one aspect of the present invention contemplates using cellulosic fibers in sheet, roll, or fluff form. In another aspect of the invention, the fibers can be in a mat of non-woven material. Fibers in mat form are not necessarily rolled up in a roll form, and typically have a density lower than fibers in the sheet form. In yet another feature of an embodiment of the invention, the fibers can be used in the wet or dry state. It is preferred that the cellulosic fibers be employed in the dry state.

The cellulosic fibers that are treated in accordance with the modifying agent with various embodiments of the present invention while in the sheet form can be any of wood pulp fibers or fibers from any other source described previously. In one embodiment of the invention, fibers in the sheet form suitable for use in the present invention include caustic-treated fibers. In addition to the advantages discussed previously, treatment of fibers with caustic adds several other advantages to the fibers. Among these are: (1) caustic-treated fibers have high α-cellulose content, since caustic removes residuals such as lignin and hemicellulose remaining on the fibers from pulping and bleaching processes; (2) caustic-treated fibers have a round, circular shape (rather than the flat, ribbon-like shape of conventional fibers) that reduces the contact and weakens the hydrogen-bonding among fibers in the sheet form; and (3) caustic treatment converts cellulose chains from their native structure form, cellulose I, to a more thermodynamically-stable and less crystalline form, cellulose II. The cellulosic chains in cellulose II are found to have an anti-parallel orientation rather than parallel orientation as in cellulose I (see, for example, R. H. Atalla, Comprehensive Natural Products Chemistry, Carbohydrates And Their Derivatives Including Tannins, Cellulose, and Related Lignins Vol. III, D. Barton and K. Nakanishi eds. pp 529-598, Elsevier Science, Ltd., Oxford, U.K. (1999)). Without wishing to be bound by theory, the above-mentioned properties of caustic-treated fibers are believed to be the reasons behind the reduced amounts of fines, knots and nits that the inventors have found exist in caustic-treated fiber treated in accordance with the present invention.

A description of the caustic extraction process can be found in Cellulose and Cellulose Derivatives, Vol. V, Partl, Ott, Spurlin, and Grafllin, eds., Interscience Publisher (1954). Briefly, the cold caustic treatment is carried out at a temperature less than about 65° C., but preferably at a temperature less than 50° C., and more preferably at a temperature between about 10° C. to 40° C. A preferred alkali metal salt solution is a sodium hydroxide solution either newly made up or as a solution by-product from a pulp or paper mill operation, e.g., hemicaustic white liquor, oxidized white liquor and the like. Other alkali metals such as ammonium hydroxide and potassium hydroxide and the like may be employed. However, from a cost standpoint, the preferred alkali metal salt is sodium hydroxide. The concentration of alkali metal salts in solution is typically in a range from about 2 to about 25 weight percent of the solution, preferably from about 3 to about 18 weight percent.

Commercially available caustic extractive pulp suitable for use in embodiments of the present invention include, for example, Porosanier-J-HP, available from Rayonier Performance Fibers Division (Jesup, Ga.), and Buckeye's HPZ products, available from Buckeye Technologies (Perry, Fla.).

In one embodiment, the modifying agent is applied to the cellulose fibers in an aqueous solution. Preferably, the aqueous solution has a pH from about 1 to about 5, more preferably from about 2 to about 3.5.

Preferably the modifying agent, after being prepared, is diluted with water to a concentration sufficient to provide from about 0.5 to 10.0 weight percent modifying agent on fiber, more preferably from about 2 to 7 weight percent, and most preferably from about 3 to 6 weight percent. By way of example, 7 weight percent modifying agent means 7 g of modifying agent per 100 g oven dried fiber.

Optionally, the method includes applying a catalyst to accelerate the reaction between hydroxyl groups of cellulose and carboxyl groups of the modifying agent of the present invention. Any catalyst known in the art to accelerate the formation of an ester bond between hydroxyl group and acid group may be used. Suitable catalysts for use in the present invention include alkali metal salts of phosphorous containing acids such as alkali metal hypophosphites, alkali metal phosphites, alkali metal polyphosphonates, alkali metal phosphates, and alkali metal sulfonates. A particularly preferred catalyst is sodium hypophosphite. The catalyst can be applied to the fibers as a mixture with the modifying agent, before the addition of the modifying agent, or after the addition of modifying agent to cellulosic fibers. A suitable ratio of catalyst to modifying agent is, for example from about 1:2 to about 1:10, and preferably from about 1:4 to about 1:8.

Optionally, in addition to the modifying agent, other finishing agents such as softening, and wetting agents also may be used. Examples of softening agents include fatty alcohols, fatty acids amides, polyglycol ethers, fatty alcohols sulfonates, and N-stearyl-urea compounds. Examples of wetting agents include fatty amines, salts of alkylnapthalenesulfonic acids, alkali metal salts of dioctyl sulfosuccinate, and the like.

Any method of applying the modifying agent to the fibers may be used. Acceptable methods include, for example, spraying, dipping, impregnation, and the like. Preferably, the fibers are impregnated with an aqueous solution containing the modifying agent. Impregnation typically creates a uniform distribution of modifying agent on the sheet and provides better penetration of modifying agent into the interior part of the fibers.

In one embodiment of the invention, a sheet of caustic-treated fibers or conventional fibers in the roll form is conveyed through a treatment zone where the modifying agent is applied on both surfaces by conventional methods such as spraying, rolling, dipping, knife-coating or any other manner of impregnation. A preferred method of applying the aqueous solution containing the modifying agent to fibers in the roll form is by puddle press, size press, or blade coater.

In one embodiment of the present invention, fibers in sheet or roll form after having been treated with a solution containing the modifying agent is then preferably transported by a conveying device such as a belt or a series of driven rollers though a two-zone oven for drying and curing.

Fibers in fluff, roll, or sheet form after treatment with the modifying agent are preferably dried and cured in a two-stage process, and more preferably dried and cured in a one-stage process. Such drying and curing removes water from the fibers, thereupon inducing the formation of an ester linkage between hydroxyl groups of the cellulosic fibers and modifying agent. Any curing temperature and time can be used so long as they produce the desired effects described herein. Using the present disclosure, persons having ordinary skill in the art can determine suitable curing temperatures and time, depending on the type of fibers and the type of treatment of the fibers.

Curing typically is carried out in a forced draft oven preferably from about 130° C. to about 225° C. (about 265° F. to about 435° F.), and more preferably from about 160° C. to about 220° C. (about 320° F. to about 430° F.), and most preferably from about 180° C. to about 215° C. (about 350° F. to about 420° F.). Curing is preferably carried out for a sufficient period of time to permit complete fiber drying and efficient bonding between cellulosic fibers and the modifying agent. Preferably, the fibers are cured from about 5 min to about 25 min, more preferably from about 7 min to about 20 min, and most preferably from about 10 min to about 15 min.

In the case where the modification is carried out on fibers in fluff form, preferably the fibers are treated initially with the modifying agent(s) while in the sheet form, dried at a temperature below curing temperature, defiberized by passing them through a hammermill or the like, and then heated at elevated temperatures to promote bonding formation between fibers and the modifying agent. In an alternate embodiment of the present invention, the cellulosic fibers in fluff form are treated initially with the modifying agent, dried at a temperature below curing, defiberized, and then cured at elevated temperature.

When the cellulosic fibers to be treated are in roll or sheet form, it is preferred that after the modifying agent is applied, the fibers are dried and then cured, and more preferably dried and cured in one procedure. In one feature of an embodiment of the present invention, the fibers in sheet or roll form after having been treated with a solution containing the modifying agent are transported by a conveying device, such as a belt or series of driven rollers, through a two-zone oven for drying and curing, preferably through a one step procedure in a one-zone oven for drying and curing. In another feature of an embodiment of the present invention, fibers in the sheet from, after having been treated with a solution containing the modifying agent preferably are transported by a conveying device, such as a belt or a series of driven rollers, through an oven for drying, and then to a hammermill for defiberization. The defiberized pulp produced by the hammermill then preferably is conveyed through an oven for curing. In another feature of an embodiment of the present invention, the defiberized pulp produced by the hammermill is airlaid into a non-woven mat, then preferably is conveyed through an oven for curing.

While not intending on being limited by any theory of operation, the reaction scheme shown below represents one of the possible fiber reactions with the modifying agent of the present invention. The scheme is provided for the purpose of illustrating, not limiting, the reaction between the cellulosic fibers and the modifying agent of the present invention. As shown in scheme 3, reaction of cellulose with the modifying agent of the present invention results in the formation of ester links. The reaction mechanism is expected to be similar to that between cellulose and conventional cross-linking agents such as, for example, alkane polycarboxylic acids. The mechanism of cross-linking cellulose with polycarboxylic acid has been described by Zhou et al., Journal of Applied Polymer Science, Vol. 58, 1523-1524 (1995) and by Lees, M. J. The Journal of Textile Institute Vol. 90 (3), 42-49 (1999). The mechanism of polycarboxylic acid cross-linking of cellulose has been shown to occur via four steps: (1) formation of a 5- or 6-membered anhydride ring from polycarboxylic acid; (2) reaction of the anhydride with a cellulose hydroxyl group to form an ester bond and link the polycarboxylic acid to cellulose; (3) formation of an additional 5- or 6-membered ring anhydride from polycarboxylic acids pendant carboxyl groups; and (4) reaction of the anhydride with free cellulose hydroxyl groups to form ester cross-links.

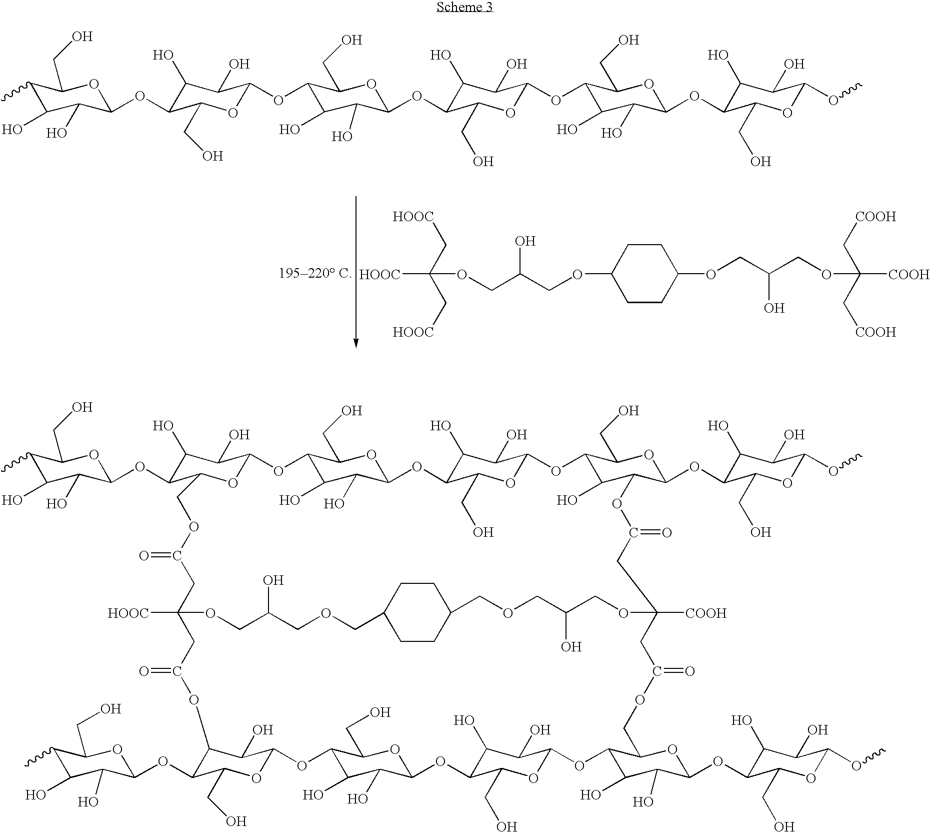

The stability of the bonds formed in the cellulosic based acquisition fibers made in accordance with the present invention was examined by an aging process described below in example 15. The cellulosic based acquisition fibers of the invention showed little or no change in bulk and performance after heating for about 20 hours at 90° C. In addition, fibers stored in an environment with 50% humidity at ambient temperature for over 3 months exhibited a bulk that remained unchanged during this period of time.

The morphologies of cellulosic based acquisition fibers of the present invention, conventional fibers (Rayfloc®-J-LD), as well as P&G cross-linked fibers were examined with Scanning Electron Microscopy (SEM) (S360 Leica Cambridge Ltd., Cambridge, England) at 15 kV. The samples were coated with platinum using a sputter coater (Desk-II, Denton Vacuum Inc.) for 90 seconds with a gas pressure of lower than about 50 mtorr and a current of about 30 mA.

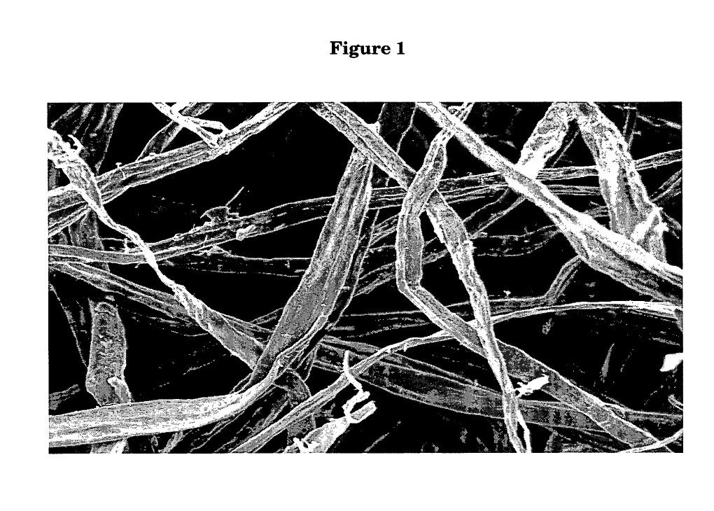

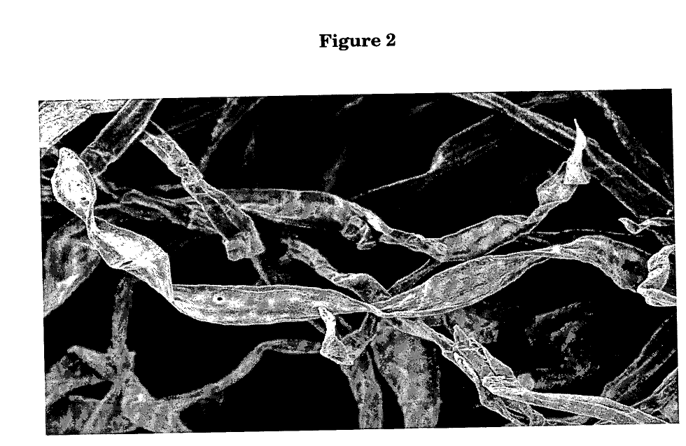

The SEM photograph illustrated in FIG. 1 represents conventional fibers (e.g., Rayfloc®-J-LD). As can be seen from the photograph, conventional fibers have a flat ribbon like shape. An SEM of P&G cross-linked fibers obtained from a Pampers diaper, as shown in FIG. 2, shows that these fibers have a flat ribbon like shape with twists and curls.

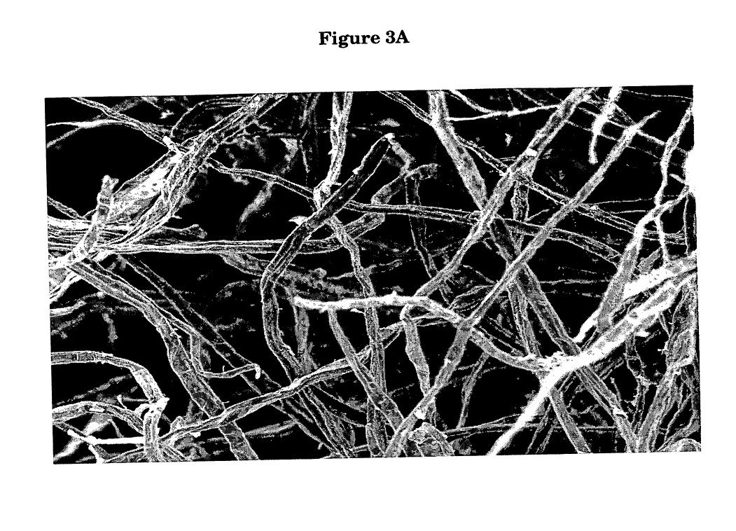

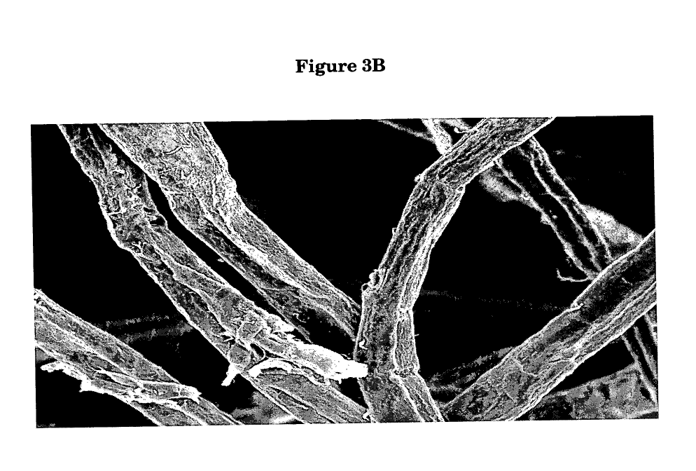

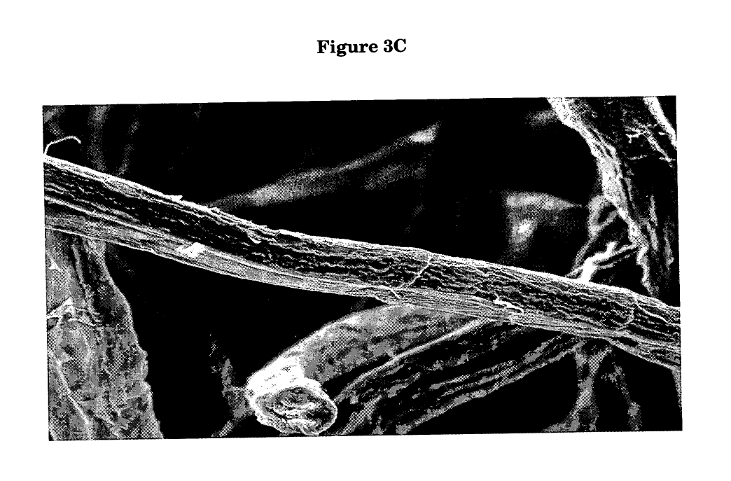

SEM photographs illustrated in FIGS. 3A, 3B, and 3C represent cellulosic based acquisition fibers of the present invention obtained by reacting conventional fibers (Rayfloc®-J-LD) in the sheet form with the modifying agent of the present invention. The photographs were taken at 100×, 200, and 1000× magnifications, respectively. As can be seen from the photographs, the modification caused Rayfloc®-J-LD fibers to fold along the longitudinal axis, and as a result the fibers became almost round.

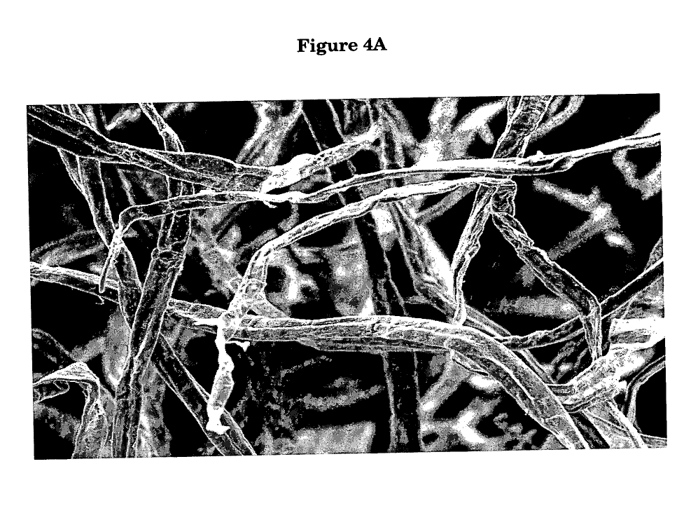

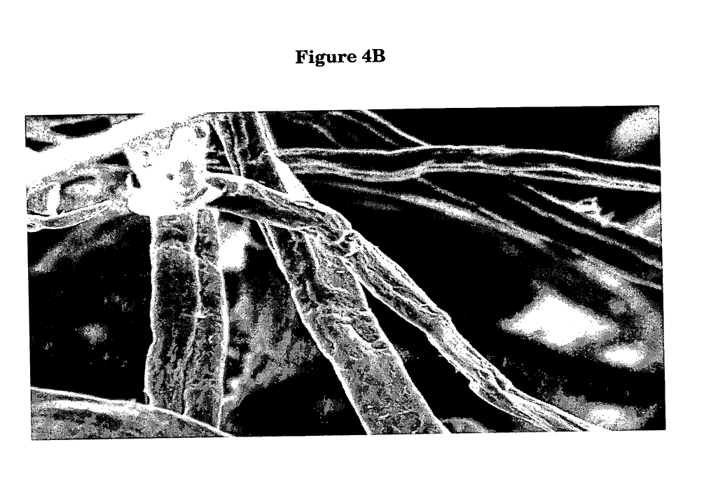

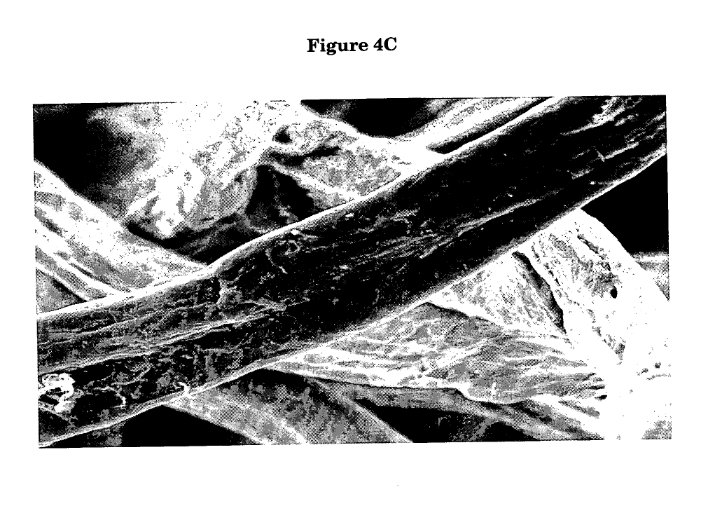

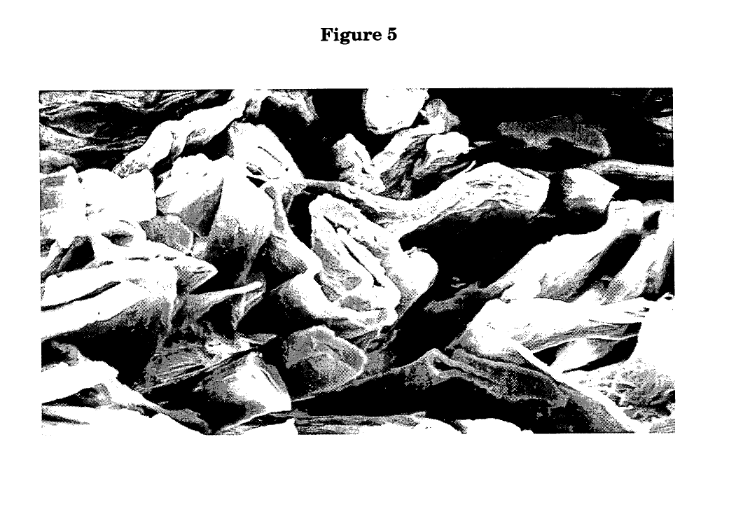

SEM photographs illustrated in FIGS. 4A, 4B, and 4C represent cellulosic based acquisition fibers of the present invention obtained by reacting conventional fibers (Rayfloc®-J-LD) in fluff form with the modifying agent of the present invention. The photographs were taken at 100×, 200, and 1000× magnifications, respectively. As was the case with cellulosic based acquisition fibers prepared in the sheet from, the modifying agent of an embodiment of the present invention caused Rayfloc®-J-LD fibers to fold along the longitudinal axis, and as a result, the fibers became almost round (see FIG. 5).

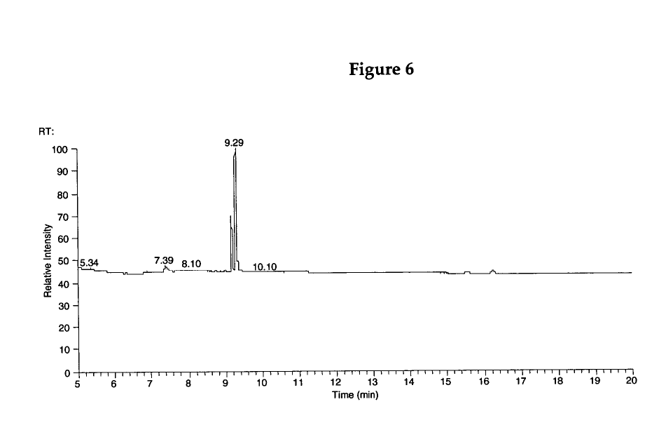

SEM analysis revealed that the cellulosic based acquisition fibers of embodiments of the present invention, and P&G cross-linked fibers differed in two ways. P&G cross-linked fibers were found to have a flat ribbon like shape with twists and curls (FIG. 2). In contrast, the cellulosic based acquisition fibers of the present invention were found to be folded along the longitudinal axis, circular, hollow (FIG. 6) and did not contain kinks or twists (FIGS. 3A, 3B, 3C), with some of the fibers being slightly bent.

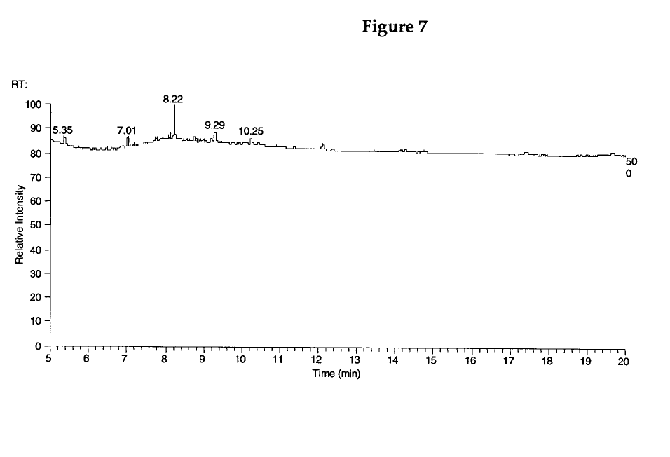

The aqueous solution containing the modifying agent of an embodiment of the present invention was analyzed by GC-MS as described in Example 13. The results revealed that the polyfunctional epoxy used in the preparation of the modifying agent was consumed almost completely. As described in Example 13, the GC-MS results revealed that the polyfunctional epoxy is present in a concentration of less than 10 ppm (FIG. 7).

Cellulosic based acquisition fibers of the present invention prepared as described in Example 5 were analyzed for any residual of polyfunctional epoxy. A sample of the cellulosic based acquisition fibers in sheet form was fluffed, and then subjected to Soxhlet extraction with methylene chloride as described in Example 19. The extract after concentration to almost dryness was diluted with hexane and analyzed by GC with dual detectors Mass Spectroscopy and Flame Ionization Detectors.

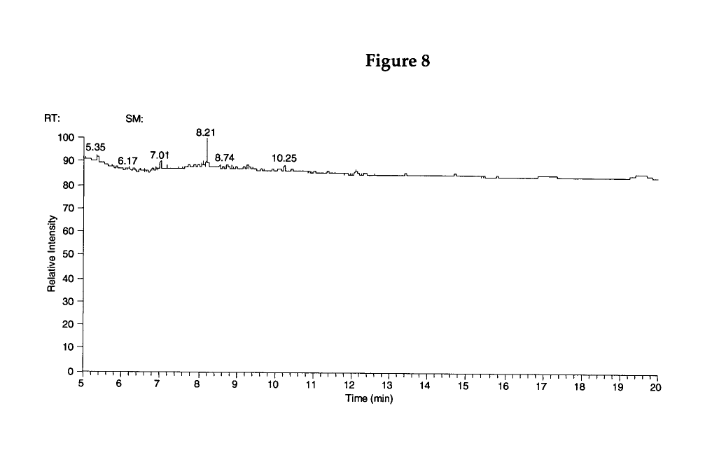

The GC-MS results were compared against a standard solution of 1,4-cyclohexanedimethanol diglycidyl ether in hexane. The resulting chromatographs are shown in FIGS. 6 and 8. FIG. 6 shows the chromatograph of standard solution of 1,4-cyclohexanedimethanol diglycidyl ether (20 ppm in hexane). FIG. 8 shows the GC results of cellulosic based acquisition fiber extracts. As shown by chromatographs in FIGS. 6 and 8, the fibers are free of any unreacted 1,4-cyclohexanedimethanol diglycidyl ether.

The cellulosic fibers modified in accordance with embodiments of the present invention preferably possess characteristics that are desirable in absorbent articles. For example, the hydrophobic cellulosic fibers preferably have a centrifuge retention capacity of less than about 0.6 grams of synthetic saline per gram of fiber (hereinafter “g/g”). The cellulosic based acquisition fibers also have other desirable properties, such as absorbent capacity of greater than about 8.0 g/g, an absorbency under load of greater than about 7.0 g/g, less than about 9.0% of fines, and an acquisition rate upon the third insult (or third insult strikethrough) of less than about 11.0 seconds. The particular characteristics of the cellulosic based acquisition fibers of the invention are determined in accordance with the procedures described in more detail in the examples.

The centrifuge retention capacity measures the ability of the fibers to retain fluid against a centrifugal force. It is preferred that the fibers of the invention have a centrifuge retention capacity of less than about 0.6 g/g, more preferably, less than about 0.55 g/g, and even more preferably less than 0.5 g/g. The cellulosic based acquisition fibers of the present invention can have a centrifuge retention capacity as low as about 0.37 g/g.

The absorbent capacity measures the ability of the fibers to absorb fluid without being subjected to a confining or restraining pressure. The absorbent capacity preferably is determined by the hanging cell method described herein. It is preferred that the fibers of the invention have an absorbent capacity of more than about 8.0 g/g, more preferably, greater than about 9.0 g/g, even more preferably greater than about 10.0 g/g, and most preferably greater than about 11.0 g/g. The cellulosic based acquisition fibers of the present invention can have an absorbent capacity as high as about 16.0 g/g.

The absorbency under load measures the ability of the fibers to absorb fluid against a restraining or confining force over a given period of time. It is preferred that the fibers of the invention have an absorbency under load of greater than about 7.0 g/g, more preferably, greater than about 8.5 g/g, and most preferably, greater than about 9.0 g/g. The cellulosic based acquisition fibers of the present invention can have absorbency under load as high as about 14.0 g/g.

The third insult strikethrough measures the ability of the fibers to acquire fluid, and is measured in terms of seconds. It is preferred that the fibers of the invention have a third insult strikethrough for absorbing 9.0 mL of 0.9% saline of less than about 11.0 seconds, more preferably, less than about 10.0 seconds, even more preferably less than 9.5 seconds, and most preferably less than about 9.0 seconds. The cellulosic based acquisition fibers of the present invention can have a third insult strikethrough of as low as about 6.0 seconds.

The cellulosic based acquisition fibers of the present invention preferably have less than about 26% of knots, more preferably less than about 20% knots, and most preferably, less than about 18% knots. The cellulosic based acquisition fibers of the present invention also preferably have less than about 10.0% of fines, preferably less than about 8.0% fines, and most preferably, less than about 7.0% fines.

It also is preferred in the present invention, that the cellulosic based acquisition fibers have a dry bulk of at least about 8.0 cm³/g fiber, more preferably at least about 9.0 cm³/g fiber, even more preferably at least about 10.0 cm³/g fiber, and most preferably at least about 11.0 cm³/g fiber.

In addition to being more economical, there are several other advantages for making acquisition fibers in the sheet form. Fibers cross-linked in sheet form have typically been expected to have an increased potential for inter-fiber cross-linking which leads to “knots” and “nits” resulting in poor performance in some applications. For instance, when a standard purity fluff pulp, Rayfloc-JLD, is cross-linked in sheet form with conventional cross-linking agents such as, for example, citric acid, the “knot” content increases substantially, indicating increased deleterious inter-fiber bonding (see Example 12, Table 5). Surprisingly, the inventors have discovered that Rayfloc-JLD treated with the modifying agent of the present invention in sheet or roll form actually yields fewer knots and nits than a commercial acquisition fibers produced by individualized cross-linked fibers, such as those produced by the Weyerhaeuser Company commonly referred to as HBA (for high-bulk additive), and by Proctor & Gamble (see Example 12, Table 5).

Another advantage of using the modifying agent of the present invention to make acquisition fibers in fluff or sheet form is that the resultant fibers are more stable to color reversion at elevated temperature. Since converting cellulosic fibers into acquisition fibers requires high temperatures (typically around 195° C. for 10-15 minutes), which can lead to substantial discoloration with the conventional cross-linking agent(s). By using the modifying agent of the present invention, this discoloration is less likely to occur.

Another benefit of the present invention is that the cellulosic based acquisition fibers made in accordance with the present invention enjoy the same or better performance characteristics as conventional individualized cross-linked cellulose fibers, but avoid the processing problems associated with dusty individualized cross-linked fibers.

The properties of the cellulosic based acquisition fibers prepared in accordance with the present invention make the fibers suitable for use, for example, as a bulking material, in the manufacturing of high bulk specialty fibers that require good absorbency and porosity. The cellulosic based acquisition fibers can be used, for example, in non-woven, fluff absorbent products. The fibers may also be used independently, or preferably incorporated into other cellulosic fibers to form blends using conventional techniques, such as air laying techniques. In an airlaid process, the cellulosic based acquisition fibers of the present invention alone or in combination with other fibers are blown onto a forming screen or drawn onto the screen via a vacuum. Wet laid processes may also be used, combining the cellulosic based acquisition fibers of the invention with other cellulosic fibers to form sheets or webs of blends.

The cellulosic based acquisition fibers of the present invention may be incorporated into various absorbent articles, preferably intended for body waste management such as adult incontinent pads, feminine care products, and infant diapers. The cellulosic based acquisition fibers can be used as an acquisition layer in the absorbent articles, and it can be utilized in the absorbent core of the absorbent articles. Towels and wipes also may be made with the cellulosic based acquisition fibers of the present invention, and other absorbent products such as filters. Accordingly, an additional feature of the present invention is to provide an absorbent article and an absorbent core that includes the cellulosic based acquisition fibers of the present invention.

The cellulosic based acquisition fibers of the present invention were incorporated into an acquisition layer of an absorbent article, and the absorbent article was evaluated by the Specific Absorption Rate Test (SART), where acquisition time of the fibers is important. The SART method is described in detail in the Examples section. It was observed that the absorbent article that contained cellulosic based acquisition fibers of the present invention provided results comparable to those obtained by using commercial cross-linked fibers, especially those cross-linked with polycarboxylic acids.

As is known in the art, absorbent cores typically are prepared using fluff pulp to wick the liquid, and an absorbent polymer (oftentimes a superabsorbent polymer (SAP)) to store liquid. As noted previously, the cellulosic based acquisition fibers of the present invention have high resiliency, high free swell capacity, high absorbent capacity and absorbency under load, and low third insult strikethrough times. Furthermore, the cellulosic based acquisition fibers of the present invention are highly porous. Accordingly, the cellulosic based acquisition fibers of the present invention can be used in combination with the SAP and conventional fibers to prepare an absorbent composite (or core) having improved porosity, bulk, resiliency, wicking, softness, absorbent capacity, absorbency under load, low third insult strikethrough, centrifuge retention capacity, and the like. The absorbent composite could be used as an absorbent core of the absorbent articles intended for body waste management.

It is preferred in the present invention that the cellulosic based acquisition fibers be present in the absorbent composite in an amount ranging from about 10 to about 80% by weight, based on the total weight of the composite. More preferably, the cellulosic based acquisition fibers are present in an absorbent composite from about 20 to about 60% by weight. A mixture of conventional cellulosic fibers and cellulosic based acquisition fibers of the present invention along with the SAP also can be used to make the absorbent composite. Preferably, the cellulosic based acquisition fibers of the present invention are present in the fiber mixture in an amount from about 1 to 70% by weight, based on the total weight of the fiber mixture, and more preferably present in an amount from about 10 to about 40% by weight. Any conventional cellulosic fibers may be used in combination with the cellulosic based acquisition fibers of the invention. Suitable additional conventional cellulosic fibers include any of the wood fibers mentioned previously, caustic-treated fibers, rayon, cotton linters, and mixtures and combinations thereof.

Any suitable SAP, or other absorbent material, can be used to form the absorbent core, and absorbent article of the present invention. The SAP can be in the form of, for example, fibers, flakes, or granules, and preferably is capable of absorbing several times its weight of saline (0.9% solution of NaCl in water) and/or blood. The SAP also preferably is capable of retaining the liquid when it is subjected to a load. Non-limiting examples of superabsorbent polymers applicable for use in the present invention include any SAP presently available on the market, including, but not limited to, polyacrylate polymers, starch graft copolymers, cellulose graft copolymers, and cross-linked carboxymethylcellulose derivatives, and mixtures and combinations thereof.

An absorbent composite made in accordance with the present invention preferably contains the SAP in an amount of from about 20 to about 60% by weight, based on the total weight of the composite, and more preferably from about 30 to about 60% by weight. The absorbent polymer may be distributed throughout an absorbent composite within the voids in the fibers. In another embodiment, the superabsorbent polymer may attached to cellulosic based acquisition fibers via a binding agent that includes, for example, a material capable of attaching the SAP to the fibers via hydrogen bonding, (see, for example, U.S. Pat. No. 5,614,570, the disclosure of which is incorporated by reference herein in its entirety).

A method of making an absorbent composite may include forming a pad of cellulosic based acquisition fibers or a mixture of cellulosic based acquisition fibers, and incorporating particles of superabsorbent polymer in the pad. The pad can be wet laid or airlaid. Preferably the pad is airlaid. It also is preferred that the SAP and cellulosic based acquisition fibers, or a mixture of cellulosic based acquisition fibers and cellulosic fibers are air-laid together.

An absorbent core containing cellulosic based acquisition fibers and superabsorbent polymer preferably has a dry density of between about 0.1 g/cm³ and 0.50 g/cm³, and more preferably from about 0.2/cm³ to 0.4 g/cm³. The absorbent core can be incorporated into a variety of absorbent articles, preferably those articles intended for body waste management, such as diapers, training pants, adult incontinence products, feminine care products, and toweling (wet and dry wipes).

In order that various embodiments of the present invention may be more fully understood, the invention will be illustrated, but not limited, by the following examples. No specific details contained therein should be understood as a limitation to the present invention except insofar as may appear in the appended claims.

### EXAMPLES

The following test methods were used to measure and determine various physical characteristics of the inventive cellulosic based acquisition fibers.

### Test Methods

The Absorbency Test Method

The absorbency test method was used to determine the absorbency under load, absorbent capacity, and centrifuge retention capacity of cellulosic based acquisition fibers of the present invention. The absorbency test was carried out in a one inch inside diameter plastic cylinder having a 100-mesh metal screen adhering to the cylinder bottom “cell,” containing a plastic spacer disk having a 0.995 inch diameter and a weight of about 4.4 g. In this test, the weight of the cell containing the spacer disk was determined to the nearest 0.001 g, and then the spacer was removed from the cylinder and about 0.35 g (dry weight basis) of cellulosic based acquisition fibers were air-laid into the cylinder. The spacer disk then was inserted back into the cylinder on the fibers, and the cylinder group was weighed to the nearest 0.001 g. The fibers in the cell was compressed with a load of 4.0 psi for 60 seconds, the load then was removed and fiber pad was allowed to equilibrate for 60 seconds. The pad thickness was measured, and the result was used to calculate the dry bulk of cellulosic based acquisition fibers.

A load of 0.3 psi then was applied to the fiber pad by placing a 100 g weight on the top of the spacer disk, and the pad was allowed to equilibrate for 60 seconds, after which the pad thickness was measured, and the result was used to calculate the dry bulk under load of the cellulosic based acquisition fibers. The cell and its contents then were hanged in a Petri dish containing a sufficient amount of saline solution (0.9% by weight saline) to touch the bottom of the cell. The cell was allowed to stand in the Petri dish for 10 minutes, and then it was removed and hanged in another empty Petri dish and allowed to drip for about 30 seconds. The 100 g weight then was removed and the weight of the cell and contents was determined. The weight of the saline solution absorbed per gram fibers then was determined and expressed as the absorbency under load (g/g). The absorbent capacity of the cellulosic based acquisition fibers was determined in the same manner as the test used to determine absorbency under load above, except that this experiment was carried using a load of 0.01 psi. The results are used to determine the weight of the saline solution absorbed per gram fiber and expressed as the absorbent capacity (g/g).

The cell then was centrifuged for 3 min at 1400 rpm (Centrifuge Model HN, International Equipment Co., Needham HTS, USA), and weighed. The results obtained were used to calculate the weight of saline solution retained per gram fiber, and expressed as the centrifuge retention capacity (g/g).

Fiber Quality

Fiber quality evaluations were carried out on an Op Test Fiber Quality Analyzer (Op Test Equipment Inc., Waterloo, Ontario, Canada) and Fluff Fiberization Measuring Instruments (Model 9010, Johnson Manufacturing, Inc., Appleton, Wis., USA).

Op Test Fiber Quality Analyzer is an optical instrument that has the capability to measure average fiber length, kink, curl, and fines content.

Fluff Fiberization Measuring Instrument is used to measure knots, nits and fine contents of fibers. In this instrument, a sample of fibers in fluff form was continuously dispersed in an air stream. During dispersion, loose fibers passed through a 16 mesh screen (1.18 mm) and then through a 42 mesh (0.36 mm) screen. Pulp bundles (knots) which remained in the dispersion chamber and those that were trapped on the 42-mesh screen were removed and weighed. The formers are called “knots” and the latter “accepts.” The combined weight of these two was subtracted from the original weight to determine the weight of fibers that passed through the 0.36 mm screen. These fibers were referred to as “fines.”

Specific Absorption Rate Test (SART)

The SART test method evaluates the performance of an acquisition layer in an absorbent article. To evaluate the acquisition properties, the Acquisition Time is measured, that is the time required for a dose of saline to be absorbed completely into an absorbent article.

In this test, the acquisition layer of the core sample is replaced with an airlaid pad made from the test fibers of the present invention. The core sample is placed into a testing apparatus (obtained from Portsmouth Tool and Die Corp., Portsmouth, Va., USA) consisting of a plastic base and a funnel cup. The base is a plastic cylinder having an inside diameter of 60.0 mm that is used to hold the sample. The funnel cup is a plastic cylinder having a hole with a star shape, the outside diameter of which is 58 mm. The funnel cup is placed inside the plastic base on top of the acquisition layer and the core sample, and a load of about 0.6 psi having a donut shape is placed on top of the funnel cup.

The apparatus and its contents are placed on a leveled surface and dosed with three successive insults, each being 9.0 ml of saline solution, (0.9% by weight), the time interval between doses being 20 min. The doses are added with a Master Flex Pump (Cole Parmer Instrument, Barrington, Ill., USA) to the funnel cup, and the time in seconds required for the saline solution of each dose to disappear from the funnel cup is recorded and expressed as an acquisition time, or strikethrough. The third insult strikethrough time is recorded.

### Example 1

This example illustrates a representative method for making a modifying agent of an embodiment of the present invention.

Cyclohexanedimethanol diglycidyl ether (20.0 g, 76.0 mmol) was added to a solution of citric acid (35.0 g, 182.0 mmol) in water (35.0 mL). The produced suspension mixture was stirred at room temperature. After about 30 min an exothermic reaction started, the stirring was continued until slightly viscose, water white solution was produced (about 30.0 min). The solution was stirred for another 18 hours, then it was diluted with distilled water to about 800 mL. Diluting the solution with water caused it to develop some cloudiness. The pH was then adjusted to about 2.9 to 3.3 with an aqueous solution of NaOH (8.3 g, 50 wt %). After stirring for a few minutes sodium hypophosphite (8.25 g, 23% by wt of citric acid) was added, followed by Triton X-100 (0.75 g, 0.0075% by total wt of solution after dilution). The stirring was continued for few more minutes after which a white water solution with negligible odor was produced. More water was then added to adjust the modifying agent concentration to about 5.5% (final weight of solution is 1.0 kg).

The produced solution then was used as is to modify fibers in the sheet form.

### Example 2

This example illustrates a representative method for making a modifying agent of an embodiment of the present invention.

Cyclohexanedimethanol diglycidyl ether (20.0 g, 76.0 mmol) was added to a solution of citric acid (35.0 g, 182.0 mmol) in water (35.0 mL). The produced suspension mixture was stirred at room temperature. After about 30 min an exothermic reaction started, the stirring was continued until slightly viscose, water white solution was produced (about 30.0 min). The solution was then heated at about 100° C. for 30 min, cooled down room temperature, and diluted with distilled water to about 800 g. Diluting the solution with water cause it to develop some cloudiness. The pH was then adjusted to about 2.9 to 3.3 with aqueous solution of NaOH. After stirring for a few minutes sodium hypophosphite (8.25 g, 23% by wt of citric acid) was added, followed by Triton X-100 (0.75 g, 0.0075% by total wt of solution after dilution to 1 kg). The stirring was continued for few more minutes after which a white water solution with negligible odor was produced. More water was then added to adjust the modifying agent concentration to about 5.5 wt. %.

The produced solution then was used as is to modify fibers in the sheet form.

### Example 3

This example illustrates a representative method for making a modifying agent of an embodiment of the present invention.

1,4-butanediol diglycidyl ether (15.4 g, 76.0 mmol) was added to a solution of citric acid (35.0 g, 182.0 mmol) in water (20.0 g). The produced solution was stirred at room temperature. After about 30 min from stirring an exothermic reaction started, the stirring was continued for another 18 hours, then the solution was diluted with distilled water to about 900 mL and the pH was adjusted to about 2.9 to 3.3 with NaOH. After stirring for a few minutes sodium hypophosphite (8.25 g, 23% by wt of citric acid) was added, and more water was added to adjust the modifying agent concentration to about 5.5%. The solution was stirred for a few more minutes then used as is in modifying conventional fiber in the sheet form.

### Example 4

Example 3 was repeated except that, in this experiment neopentyldiglycidyl ether was reacted with citric acid, in the same manner.

### Example 5

This example illustrates a representative method for making cellulosic based acquisition fibers of an embodiment the present invention using the modifying agent prepared in example 1.

Rayfloc®-J-LD, commercially available from the Rayonier mill at Jesup, Ga., was obtained in roll form. A sheet (12×12 inch), with a basis weight of about 680 gsm was obtained from the roll. The sheet was dipped in a solution containing the modifying agent prepared in Example 1, then pressed to achieve the desired level of modifying agent (about 5.5 wt. %). The sheet was then dried and cured at about 195° C. The curing was carried out in an air driven laboratory oven for about 15 min. The sheet was then defiberized by feeding it through a hammermill. Absorbent properties of the produced cellulosic based acquisition fibers were then evaluated and results are summarized in Table 1

### Example 6

The procedure of Example 5 was repeated, except that in this example a sheet of Rayfloc®-J-LD treated with 7 wt. % caustic was used. The sheet was obtained from a jumbo roll made at the Rayonier mill at Jesup, Ga. The sheet was 12×12 inch, with a basis weight of about 720 gsm. Absorbent properties of the produced cellulosic based acquisition fibers were then evaluated and results are summarized in Table 1.

### Example 7

The procedure of Example 5 was repeated, except that in this example a partially de-bonded sheet of Rayfloc®-J-MX, commercially available from the Rayonier mill at Jesup, Ga. was used. The sheet was obtained from a jumbo roll. The sheet was 12×12 inch, with a basis weight of about 720 gsm. Absorbent properties of the produced cellulosic-based acquisition fibers were then evaluated and the results are summarized in Table 1.

TABLE 1
Absorbent properties of cellulosic based acquisition fibers,
using modifying agent of Example 1: 5.5 wt % modifying agent,
dried and cured at 195° C. for 15 min.

| | Absorbent | Absorbency | Centrifuge | Knots | |
|---|---|---|---|---|---|
| | Capacity | Under Load | Retention | and nits | Fines |
| Fiber Kind | (g/g) | (g/g) | (g/g) | (%) | (%) |
| Rayfloc ®-J-LD | 11.9 | 9.8 | 0.52 | 26.7 | 6.9 |
| Rayfloc ®-J-MX | 11.8 | 9.4 | 0.49 | 20.7 | 6.5 |
| Rayfloc ®-J-LD | 12.4 | 10.8 | 0.53 | 1.93 | 6.2 |
| (7% caustic | | | | | |
| treated) | | | | | |
| Rayfloc ®-J-LD¹ | 16.8 | 13.3 | 0.49 | 2.7 | 5.2 |

¹Fibers modified in fluff form as described in Example 11 below.

### Example 8

This example illustrates the effect of curing temperature on absorbent properties of a representative cellulosic based acquisition fibers. Three sheets (12×12 inch), each weighing about 60.0 g (dry weight base) were obtained from a jumbo roll of Rayfloc®-J-LD made at Rayonier mill at Jesup, Ga. The sheets were treated with an aqueous solution containing the modifying agent prepared in Example 1 at room temperature and pressed to provide the desired level of modifying agent on fibers of about 5.5 wt %. The treated sheets then were cured at various cure temperatures for about 15 min. Absorbent properties of modified sheets as a function of cure temperature were evaluated and results are summarized in Table 2.

TABLE 2
Absorbent properties of cellulosic based acquisition
fibers with various curing temperatures

| Curing | Absorbent | Absorbency | Centrifuge |
|---|---|---|---|
| Temperature | Capacity | Under Load | Retention |
| ° C. | (g/g) | (g/g) | (g/g) |
| 175 | 12.0 | 9.7 | 0.55 |
| 185 | 11.7 | 9.0 | 0.52 |
| 195 | 11.9 | 9.8 | 0.52 |

### Example 9

This example illustrates the effect of varying the amount and the composition of modifying agent on absorbent properties of cellulosic based acquisition fibers formed in accordance with the present invention.

Pulp sheets (12×12 inch) of Rayfloc®-J-LD, each weighing about 60.0 g (dry weight base) obtained from a jumbo roll as shown in example 5 were used in this example. The sheets were treated with an aqueous solution containing the modifying agent prepared in accordance with example 1 at various concentrations and pressed to provide the desired level of modifying agent on the fibers. Sheets were then cured at 195° C. for 15 min. The results are summarized in Table 3.

TABLE 3
Absorbent properties of cellulosic based acquisition fibers,
treated with modifying agent with various compositions

| Composition of | | | | | |
|---|---|---|---|---|---|
| Modifying Agent | | Modifying | Absorbent | | |
| Citric | | Agent on | Capacity | Absorbency | Centrifuge |
| Acid % | CHDMDGE | Fiber | (0.3 psi) | Under Load | Retention |
| (w/w) | % (w/w) | wt. % | (g/g) | (g/g) | (g/g) |
| 3.0 | 2.0 | 5.0 | 12.0 | 10.3 | 0.55 |
| 3.5 | 2.0 | 5.5 | 11.9 | 9.8 | 0.52 |
| 4.0 | 2.0 | 6.0 | 11.5 | 9.0 | 0.49 |
| 4.5 | 2.0 | 6.5 | 10.8 | 9.0 | 0.46 |
| 3.5 | 1.5 | 5.0 | 11.8 | 9.0 | 0.53 |
| 4.0 | 1.5 | 5.5 | 10.1 | 8.3 | 0.49 |

### Example 10

This example illustrates the effect of using various modifying agents prepared using various polyepoxy compounds on absorbent properties of representative cellulosic based acquisition fibers formed in accordance with the present invention.

The modifying agents were prepared in accordance with Examples 1, 3, and 4. Solutions containing modifying agents were then used to modify Rayfloc®-J-LD fibers as shown in Example 5. Absorbent properties of the cellulosic based acquisition fibers were then evaluated. The results are summarized in Table 4.

TABLE 4
Absorbent properties of cellulosic based acquisition fibers
using modifying agents prepared from various polyepoxy compounds

| Composition | | | Absorbent Capacity | Absorbency | Centrifuge |
|---|---|---|---|---|---|
| of Modifying | | Method of | (0.3 psi) | under Load | Retention |
| Agent | | preparation | (g/g) | (g/g) | (g/g) |
| Citric acid | CHDMDGE | Example 1 | 11.9 | 9.8 | 0.52 |
| Citric acid | BDDGE | Example 3 | 11.3 | 8.6 | 0.54 |
| Citric acid | NPGDHE | Example 4 | 12.9 | 9.3 | 0.54 |

In Table 4 above, the abbreviations used to describe the modifying agents are as follows:
CHDMDGE=1,4-cyclohexanoldimethanol diglycidyl ether.
BDDGE=1,4-butanediol diglycidyl ether.
NPGDGE=Neopentylglycol diglycidyl ether.

### Example 11

This example illustrates a representative method for making cellulosic based acquisition fibers in fluff form.

A sample of Rayfloc®-J-LD (never dried, dry fibers can be also used) was obtained as a 33.7% solid wet lap from Rayonier mill at Jesup, Ga. A 70.0 g (dry weight base) sample was treated with a 5.5 wt % aqueous solution containing the modifying agent prepared in Example 1 by dipping and pressing to about 100% pick-up, that afford about 5.5 wt % of modifying agent on fibers. The treated fibers were then dried in a laboratory oven at about 60° C., defiberized by feeding it through a hammermill (Kamas Mill H01, Kamas Industries AB, Vellinge, Sweden) then cured at 195° C. for 8 min. Fiber absorbent properties and bulk were then evaluated. Results are summarized in Table 1 above.

### Example 12

The cellulosic based acquisition fibers of embodiments of the present invention were analyzed for fine, fiber length, kink angle, and knots and nits. The results obtained are summarized in Table 5. Also summarized in Table 5 are the results of the analysis of commercial modified fibers and conventional unmodified fibers. The data in Table 5 demonstrate that the cellulosic based acquisition fibers of the present invention have reduced contents of knots and nits compared to commercial fibers cross-linked in individualized form. In addition to that the present fibers have a kink angle almost equal to that of conventional unmodified cellulosic fibers and much lower than that of the commercial cross-linked fibers.

TABLE 5
Fiber quality of representative cellulosic based acquisition
fibers and commercial fibers

| | | | | Fiber | |
|---|---|---|---|---|---|
| | Method of | | | Length | Kink |
| Starting Fiber | Preparation | Fines % | Knots % | (mm) | Angle |
| Rayfloc ®-J-LD | | 5.1 | 6.2 | 2.47 | 44.7 |
| P & G (Pamper ® AL)¹ | | 4.0 | 29.0 | 2.78 | 95.2 |
| HBA | | | | | |
| Rayfloc ®-J-LD (sheet form) | Example 5 (citric | 7.4 | 58.0 | | |
| | acid (3.5%) was | | | | |
| | used alone) | | | | |
| Rayfloc ®-J-LD (sheet form)¹ | DP60 (5.5%)² | 8.5 | 44.4 | | |
| Rayfloc ®-J-LD (sheet form) | Example 5 | 6.9 | 27.0 | 1.96 | 49.0 |
| Rayfloc ®-J-LD (fluff form) | Example | 5.2 | 2.7 | 2.28 | |
| Rayfloc ®-J-LD (cold caustic | Example | 6.2 | 2.0 | 1.91 | 69.2 |
| treated 7%) | | | | | |
| Rayfloc ®-J-MX | Example | 6.5 | 20.7 | 1.96 | 39.6 |

¹Prepared as shown in Example 5 except that Belclene ® DP60 was used as a modifying agent (Belclene ® DP-60 is a mixture of polymaleic acid terpolymer with the maleic acid monomeric unit predominating (molecular weight of about 1000) and citric acid sold by BioLab Industrial Water Additives Division).

### Example 13

This example describes the method used to analyze a representative aqueous solution containing the modifying agent made in accordance with an embodiment of the present invention as described in Example 1. Approximately 100.0 g of the modifying agent were placed in a 0.5 L round bottom flask along with 200 mL methylene chloride. The mixture was stirred vigorously for about 10 minutes and then transferred to a separatory funnel. The methylene chloride layer was removed, dried with anhydrous Na₂CO₃, filtered, and evaporated to dryness at room temperature on a Rotavapor. The residue was then diluted with hexane (5.0 g). The diluted residue was then analyzed by GC with Flame Ionization and Mass Spectroscopy detectors. Comparing the results to a calibration curve indicates that greater than 95% of the 1,4-cyclohexane diglycidyl ether was reacted.

The analysis was carried out on Trace-GC 2000 (Therom Finnigan, Austin Tex. with MS and FID detectors.
Chromatography Column: CAP RTX-5 Length=30 cm; i.d.=0.25 mm Control: Flow=1.000 ml/min; Stop Time=30.00 min.

### Example 14

This example describes the test method used to study the extract of cellulosic based acquisition fibers of the present invention. The fibers used in this example were produced in accordance with Example 5. Modified fibers after defiberization (20.0 g) were subjected to Soxhlet extraction with methylene chloride for about 6 hours, the extract was filtered, concentrated by reducing its volume in a Rotavapor at 30° C. under reduced pressure. The extracts were then subjected for analysis by GC-MS. The results indicated the complete absence of 1,4-cyclohexanedimethanol diglycidyl ether.

### Example 15

This example describes the “aging” test method used to study the resistance of representative samples of cellulosic based acquisition fibers made in accordance with embodiments of the present invention to revert to unmodified fibers. Such reversion was observed in traditional cross-linked fibers made from cross-linking fibers with alkane polycarboxylic acids, such as citric acid.

The aging test was carried out on two representative samples of cellulosic based acquisition fibers made in accordance with embodiments of the present invention in the sheet form, as described in Example 5 above. Each sample weighed about 2.000 g, the samples were airlaid to pads each having a diameter of about 60.4 mm. One pad served as a blank, and the other was aged by heating it in an oven with a controlled humidity of 80% to about 85% at 90° C. for 20 hours. After the setting time, the sample pad was allowed to equilibrate in a 50% humidity environment at room temperature for about 8-days. The two pads (sample and blank) then were compressed with a load of about 7.6 psi for 60 seconds, the weights were removed, and the pads were allowed to equilibrate for 1 minute. The thickness of the pads was measured and the density was determined.

The absorbent properties of blank and sample were determined by the absorbency test method described above. The results are summarized in Table 6 below.

TABLE 6
Absorbent properties of aged cellulosic based acquisition fibers

| | | Density | | | | |
|---|---|---|---|---|---|---|
| Cellulosic- | | (Dry fiber) | Density | | | |
| Based | Density | Under | (Wet | | | Centrifuge |
| Acquisition | (Dry fiber) | Load | fiber) | Absorbency | Absorbent | Retention |
| Fiber | cc/g | (0.3 psi) | cc/g | Under Load g/g | capacity g/g | g/g |
| Before | 0.069 | 0.085 | 0.084 | 9.0 | 11.5 | 0.50 |
| aging | | | | | | |
| After | 0.067 | 0.087 | 0.085 | 10.0 | 11.9 | 0.50 |
| aging | | | | | | |

The results summarized in Table 6 reveal that the bulk and centrifuge retention of cellulosic based acquisition fibers remained unchanged after heating the fibers at elevated temperature and storing them for a long period of time. These results indicate that the cross-linkages in the cellulosic based acquisition fibers in accordance with the present invention are stable.

### Example 16

The cellulosic based acquisition fibers made in accordance with an embodiment of the present invention were tested for liquid acquisition properties. To evaluate the acquisition properties, the Acquisition Time was measured. The Acquisition Time is the time required for a dose of saline to be absorbed completely into the absorbent article.

The Acquisition Time was determined by the SART test method, described above. The test was conducted on an absorbent core obtained from a commercially available diaper stage 3 (Huggies®, from Kimberly-Clark). A sample core was cut from the center of the diaper, had a circular shape with a diameter of about 60.0 mm, and weighed about 2.8 g (±0.2 g).

In this test, the acquisition layer of the sample core was replaced with an airlaid pad made from the cellulosic based acquisition fibers of an embodiment of the present invention. The fiber pad weighed about 0.7 g and was compacted to a thickness of about 3.0 to about 3.4 mm before it was used.

The core sample including the acquisition layer was placed into the testing acquisition apparatus. The acquisition apparatus and its contents were placed on a leveled surface and dosed with three successive insults, each being 9.0 ml of saline solution, (0.9% by weight), the time interval between doses being 20 min. The time in seconds required for the saline solution of each dose to disappear from the funnel cup was recorded and expressed as an acquisition time, or strikethrough. The third insult strikethrough time is provided in Table 7 below. The data in Table 7 includes the results obtained from testing acquisition layers of commercial cross-linked fibers and conventional uncross-linked fibers. It can be seen from Table 7 that the acquisition times of the modified fibers of embodiments of the present invention are as good as or better than the acquisition time for the commercial cross-linked fibers.

TABLE 7
Liquid acquisition time for absorbent products containing
representative cellulosic based acquisition fibers and commercial fibers

| | | 3^{rd} |
|---|---|---|
| | Method of | Insult |
| Starting Fiber | Modification | (sec) |
| Huggies¹ | | 11.0 |
| Huggies² | | 14.5 |
| P & G (Pampers ® AL material) | | 9.1 |
| Rayfloc ®-J-LD (sheet form) | Example 5 | 9.4 |
| Rayfloc ®-J-LD (treated with 7% | Example 6 | 8.3 |
| caustic) | | |
| Rayfloc ®-J-MX (sheet form) | Example 7 | 10.3 |
| Rayfloc ®-J-LD (fluff form) | Example 11 | 5.1 |

¹Synthetic fiber (weight = 0.72 g, basis weight = 255 g/m²)
²Synthetic fiber (weight = 0.36 g, basis weight = 127 g/m²)

### Example 17

The cellulosic based acquisition fibers made in accordance with the present invention were evaluated for acquisition and rewet. The test measures the rate of absorption of multiple fluid insults to an absorbent product and the amount of fluid which can be detected on the surface of the absorbent structure after its saturation with a given amount of saline while the structure under a load of 0.5 psi. This method is suitable for all types of absorbent material, especially those intended for urine application.

Acquisition and rewet for the cellulosic based acquisition fibers of the present invention as well as for commercial cross-linked fibers were determined using standard procedures well known in the art.

The fluid acquisition and rewet test initially records the dry weight of a 40 cm by 12 cm (or other desired size) test specimen of the absorbent product or material. An airlaid pad of cellulosic acquisition fiber with the dimensions similar to the absorbent product was placed on top of the absorbent product. The fiber pad weighed about 4.5 g and was compacted to a density of about 0.8 g/cm³ before it was used. Then, a 100 mL, fixed volume amount of saline solution is applied to the test specimen through a fluid delivery column at a 1 inch diameter impact zone under a 0.1 psi load. The time (in seconds) for the entire 80 milliliters of solution to be absorbed is recorded as the “acquisition time,” and then the test specimen is left undisturbed for a 30 minute waiting period. A previously weighed a stack of filter paper (e.g.,15 of Whatman #4 (70 mm)) is placed over the solution the insult point on the test sample., and a 0.5 psi load (2.5 kg) is then placed on the stack of the filter papers on the test sample for 2 minutes. The wet filter papers are then removed, and the wet weight is recorded. The difference between the initial dry weight of the filter papers and final wet filter weight is recorded as the “rewet value” of the test specimen. This entire test is repeated 2 times on the same wet test specimen and in the same position as before. Each acquisition time and rewet volume is reported along with the average and the standard deviation. The “acquisition rate” is determined by dividing the 80 mL volume of liquid used by the acquisition time previously recorded. For any specimen having one embossed side, the embossed side is the side initially subjected to the test fluid.

TABLE 8
Acquisition and rewet for absorbent articles¹ containing
representative cellulosic based acquisition fibers and commercial fibers

| | Rate of | Rate of | Rate of | | | Rewet |
|---|---|---|---|---|---|---|
| | 1^{st} | 2^{nd} | 3^{rd} | Rewet | Rewet | 3^{rd} |
| Modified | insult | insult | insult | 1^{st} (g | 2^{nd} (g | (g |
| Fiber² | (ml/sec) | (ml/sec) | (ml/sec) | saline) | saline) | saline) |
| STCC³ | 6.0 | 4.0 | 3.0 | 0.03 | 0.03 | 9.45 |
| Rayfloc ®- | 5.0 | 4.0 | 3.0 | 0.08 | 1.31 | 17.0 |
| J-LD | | | | | | |
| (sheet form)⁴ | | | | | | |
| Rayfloc ®- | 8.8 | 5.4 | 4.0 | 0.03 | 0.2 | 3.8 |
| J-LD | | | | | | |
| (fluff from)⁵ | | | | | | |
| Caustic(7%) | 10.0 | 6.3 | 4.1 | 0.04 | 0.2 | 4.01 |
| treated fiber (in | | | | | | |
| fluff form)⁵ | | | | | | |

¹The core was obtained from Pampers ® diaper level 4.
²The bulk and the density of the fibers used in this experiment are approximately equal.
³Individualized cross-linked fiber produced by Weyerhaeuser.
⁴Prepared in accordance with the present invention as shown in Example 5.
⁵Prepared in accordance with the present invention as shown in Example 11.

### Example 18

This example shows the method used to determine the ISO brightness of the cellulosic based acquisition fibers of the present invention. The cellulosic based acquisition fibers produced in accordance with the present invention in sheet from were defiberized by feeding the sheet through a hammermill then airlaid as shown in example 16. The produced pad was then evaluated for ISO brightness in accordance with TAPPI test methods T272 and T525. The results are summarized in Table 9 below:

TABLE 9
ISO Brightness

| | Method of | |
|---|---|---|
| Modified Fiber | Modification | ISO Brightness |
| Rayfloc ®-J-LD | | 84.6 |
| conventional | | |
| Rayfloc ®-J-LD | 5 | 77.0 |
| Rayfloc ®-J-LD | 6 | 84.0 |
| (treated with 7% | | |
| caustic) | | |
| Rayfloc ®-J-MX | 7 | 77.0 |

The results of Table 9 reveal that cellulosic based acquisition fibers made in accordance with the present invention provide improved ISO brightness, when compared to conventional cross-linked fibers.

While the invention has been described with reference to particularly preferred embodiments and examples, those skilled in the art recognize that various modifications may

1. A modifying agent for making cellulosic acquisition fibers in sheet form, wherein the modifying agent is the reaction product of a polycarboxylic acid and a polyfunctional epoxy.

2. The modifying agent of claim 1, wherein the polycarboxylic acid comprises at least one hydroxyl functional group.

3. The modifying agent of claim 1, wherein the polycarboxylic acid comprises at least one amino functional group.

4. The modifying agent of claim 1, wherein the polycarboxylic acid is an alkanepolycarboxylic acid.

5. The modifying agent of claim 4, wherein the alkanepolycarboxylic acid is selected from the group consisting of: 1,2,3,4-butanetetracarboxylic acid; 1,2,3-propanetricarboxylic acid; oxydisuccinic acid; citric acid; itaconic acid; maleic acid; tartaric acid; glutaric acid; iminodiacetic acid, and mixtures and combinations thereof.

6. The modifying agent of claim 1, wherein the polyfunctional epoxy comprises a substituent selected from the group consisting of: hydrogen; saturated, unsaturated, cyclic-saturated, cyclic-unsaturated, branched or unbranched alkyl groups; and combinations and mixtures thereof.

7. The modifying agent of claim 1, wherein the polyfunctional epoxy is selected from the group consisting of: 1,4-cyclohexanedimethanol diglycidyl ether; diglycidyl 1,2-cyclohexanedicarboxylate; diglycidyl 1,2,3,4-tetrahydrophthalate; glycerol propoxylate triglycidyl ether; 1,4-butanediol diglycidyl ether; neopentylglycol diglycidyl ether; and combinations and mixtures thereof.

8. A process for making the modifying agent of claim 1, the process comprising reacting polycarboxylic acid compound and polyfunctional epoxy compound in aqueous medium.

9. The process of claim 8, wherein the polycarboxylic acid and polyfunctional epoxy are mixed in a mole ratio of from about 1:1 to about 3:1.

10. The process of claim 8, wherein the reaction mixture additionally comprises a catalyst to accelerate the formation of an ether bond between a hydroxyl group of the polycarboxylic acid and an epoxide group of the polyfunctional epoxy.

11. The process of claim 10, wherein the catalyst is a Lewis acid selected from the group consisting of: aluminum sulfate, magnesium sulfate, and any Lewis acid containing a metal and a halogen.

12. The process of claim 8, wherein the reaction between polycarboxylic acid and polyfunctional epoxy is carried out at a temperature range of from about room temperature to reflux temperature.

13. The process of claim 8, wherein the reaction between polycarboxylic acid and polyfunctional epoxy is carried out at room temperature for at least about 6 hours.

14. The process of claim 8, wherein the reaction between polycarboxylic acid and polyfunctional epoxy is carried out at room temperature for at least about 10 hours.

15. The process of claim 8, wherein the reaction between polycarboxylic acid and polyfunctional epoxy is carried out at room temperature for at least about 16 hours.

16. A method of making cellulosic based acquisition fibers comprising:
providing a solution of modifying agent comprising the modifying agent of claim 1;
providing cellulosic based fiber;
applying the solution of the modifying agent to the cellulosic based fiber to impregnate the cellulosic based fiber with the modifying agent; and
drying and curing the impregnated cellulosic based fiber.

17. The method of claim 16, wherein the solution of the modifying agent additionally comprises a surfactant.

18. The method of claim 17, wherein the surfactant is added in an amount of from about 0.001 to about 0.2 wt % based on the total weight of the aqueous mixture.

19. The method of claim 17, wherein the surfactant is selected from the group consisting of: Triton X-100, Triton X-405, Triton GR-5, sodium lauryl sulfate, lauryl bromoethyl ammonium chloride, ethoxylated nonylphenols, and polyethylene alkyl ethers.

20. The method of claim 16, wherein the solution of the modifying agent has a pH of about 1.5 to about 5.

21. The method of claim 16, wherein the solution of the modifying agent has a pH of about 1.5 to about 3.5.

22. The method of claim 16, wherein applying the solution of the modifying agent to the cellulosic based fiber comprises a method selected from the group consisting of: spraying, dipping, rolling, or applying with a puddle press, size press or a blade-coater.

23. The method of claim 16, wherein the cellulosic based fiber is provided in sheet form.

24. The method of claim 16, wherein the cellulosic based fiber is provided in fluff form.

25. The method of claim 16 wherein the cellulosic based fiber is provided in nonwoven mat form.

26. The method of claim 16, wherein the solution of the modifying agent is applied to the cellulosic based fiber to provide about 40% to about 150% by weight, of solution on fiber based on the total weight of the fiber.

27. The method of claim 16, wherein the concentration of the modifying agent in the solution is within the range of from about 2 wt % to about 7 wt %.

28. The method of claim 16, wherein the solution of the modifying agent is applied to the cellulosic based fiber to provide about 0.8% to 10.5% modifying agent by weight, based on the oven dried weight of the fiber.

29. The method of claim 16, wherein the solution of the modifying agent is applied to the cellulosic based fiber to provide about 3 to 6% modifying agent by weight, based on the total weight of the fiber.

30. The method of claim 16, wherein the solution of the modifying agent further comprises a catalyst to accelerate the formation of an ester link between the hydroxyl groups of the cellulosic based fiber and the carboxyl groups of the modifying agent.

31. The method of claim 30, wherein the catalyst is selected from the group consisting of alkali metal salts of phosphorous containing acids such as alkali metal hypophosphites, alkali metal phosphites, alkali metal polyphosphonates, alkali metal phosphates, and alkali metal sulfonates.

32. The method of claim 30, wherein the catalyst is added in an amount of from about 0.1 to 0.5 weight %, based on the total weight of the modifying agent.

33. The method of claim 16, wherein the cellulosic based fiber is provided in a dry state.

34. The method of claim 16, wherein the cellulosic based fiber is provided in a wet state.

35. The method of claim 16, wherein the cellulosic based fiber is a conventional cellulose fiber.

36. The method of claim 35, wherein the conventional cellulose fiber is wood pulp fiber selected from the group consisting of: hardwood cellulose pulp, softwood cellulose pulp obtained from a Kraft or sulfite chemical process, and combinations and mixtures thereof.

37. The method of claim 36, wherein the hardwood cellulose pulp is selected from the group consisting of: gum, maple, oak, eucalyptus, poplar, beech, aspen, and combinations and mixtures thereof.

38. The method of claim 36, wherein the soft cellulose pulp is selected from the group consisting of Southern pine, White pine, Caribbean pine, Western hemlock, spruce, Douglas fir, and mixtures and combinations thereof.

39. The method of claim 35, wherein the conventional cellulose fiber is derived from one or more components selected from the group consisting of: cotton fibers, cotton linters, bagasse, kemp, flax, grass, and combinations and mixtures thereof.

40. The method of claim 16, wherein the provided cellulosic based fiber is a caustic-treated fiber.

41. The method of claim 40, wherein the caustic-treated fiber is prepared by treating a liquid suspension of pulp at a temperature of from about 5° C. to about 85° C. with an aqueous alkali metal salt solution having an alkali metal salt concentration of about 2 weight percent to about 25 weight percent of said solution for a period of time ranging from about 5 minutes to about 60 minutes.

42. The method of claim 40, wherein the cellulosic based fiber is selected from the group consisting of non-bleached, partially bleached and fully bleached cellulosic fibers.

43. The method of claim 16, wherein the drying and curing occurs in a one-step process.

44. The method of claim 16, wherein the drying and curing is conducted at a temperature within the range of about 130° C. to about 225° C.

45. The method of claim 16, wherein the drying and curing is conducted for about 3 minutes to about 15 minutes at temperatures within the range of about 130° C. to 225° C.

46. The method of claim 16, wherein the drying and curing occurs in a two-step process.

47. The method of claim 46, wherein the drying and curing comprises:
first drying the impregnated cellulosic fiber, and
curing the dried cellulosic fiber.

48. The method of claim 46, wherein the drying and curing comprises:
drying the impregnated cellulosic fiber at a temperature below curing temperature, and
curing the dried impregnated cellulosic fiber for about 1 to 10 minutes at a temperature within the range of about 150° C. to about 225° C.

49. The method of claim 46, wherein the drying and curing comprises:
drying the impregnated cellulosic fiber at a temperature within the range of about room temperature to about 130° C., and
curing the dried impregnated cellulosic fiber for about 0.5 to about 5 minutes at a temperature within the range of about 130° C. to about 225° C.

50. The cellulosic based acquisition fibers produced by the method of claim 16.

51. The fiber of claim 50, whereby the cellulosic based acquisition fibers have a centrifuge retention capacity of less than about 0.6 grams of a 0.9% by weight saline solution per gram of oven dried fiber.

52. The fiber of claim 50, whereby the cellulosic based acquisition fibers have a centrifuge retention capacity of less than about 0.55 gram saline/gram oven dried fiber.

53. The fiber of claim 50, whereby the cellulosic based acquisition fibers have a centrifuge retention capacity of less than about 0.5 gram saline/g oven dried fiber.

54. The fiber of claim 50, whereby the cellulosic based acquisition fibers have an absorbent capacity of at least about 8.0 g saline/gram oven dried fiber.

55. The fiber of claim 50, whereby the cellulosic based acquisition fibers have an absorbent capacity of at least about 9.0 g saline/gram oven dried fiber.

56. The fiber of claim 50, whereby the cellulosic based acquisition fibers have an absorbent capacity of at least about 10.0 g saline/gram oven dried fiber.

57. The fiber of claim 50, whereby the cellulosic based acquisition fibers have an absorbent capacity of at least about 11.0 g saline/gram oven dried fiber.

58. The fiber of claim 50, whereby the cellulosic based acquisition fibers have an absorbency under load of at least about 7.0 g saline/gram oven dried fiber.

59. The fiber of claim 50, whereby the cellulosic based acquisition fibers have an absorbency under load of at least about 8.5 g saline/gram oven dried fiber.

60. The fiber of claim 50, whereby the cellulosic based acquisition fibers have an absorbency under load of at least about 9.0 g saline/gram oven dried fiber.

61. The fiber of claim 50, whereby the cellulosic based acquisition fibers have a dry bulk of at least about 8.0 cm³/gram oven dried fiber.

62. The fiber of claim 50, whereby the cellulosic based acquisition fibers have a dry bulk of at least about 9.0 cm³/gram oven dried fiber.

63. The fiber of claim 50, whereby the cellulosic based acquisition fibers have a dry bulk of at least about 10.0 cm³/gram oven dried fiber.

64. The fiber of claim 50, whereby the cellulosic based acquisition fibers have a dry bulk of at least about 11.0 cm³/gram oven dried fiber.

65. The fiber of claim 50, whereby the cellulosic based acquisition fibers after defiberization have a knot and nit content of less than about 26%.

66. The fiber of claim 50, whereby the cellulosic based acquisition fibers after defiberization have a knot and nit content of less than about 20%.

67. The fiber of claim 50, whereby the cellulosic based acquisition fibers after defiberization have a knot and nit content of less than about 18%.

68. The fiber of claim 50, whereby the cellulosic based acquisition fibers after defiberization have a fines content of less than about 10%.

69. The fiber of claim 50, whereby the cellulosic based acquisition fibers after defiberization have a fines content of less than about 9%.

70. The fiber of claim 50, whereby the cellulosic based acquisition fibers after defiberization have a fines content of less than about 8%.

71. The fiber of claim 50, whereby the cellulosic based acquisition fibers after defiberization have a fines content of less than about 7%.

72. The fiber of claim 50, wherein the cellulosic based acquisition fibers have an ISO Brightness of greater than 70%.

73. The fiber of claim 50, whereby the cellulosic based acquisition fibers have a centrifuge retention capacity of less than about 0.55 g saline/gram oven dried fiber and an ISO Brightness of greater than 75%.

74. The fiber of claim 50, whereby the cellulosic based acquisition fibers after defiberization in Kamas provide fibers with greater than 75% accept, wherein the defiberized fibers have a centrifuge retention capacity of less than about 0.55 g saline/gram oven dried fiber and an ISO Brightness of greater than 75%.

75. An absorbent article comprising the cellulosic based acquisition fibers of claim 50.

76. The absorbent article of claim 75, wherein the absorbent article is at least one article selected from the group consisting of infant diapers, feminine care products, training pants, and adult incontinence briefs.

77. The absorbent article of claim 75, wherein the absorbent article comprises a liquid penetrable top sheet, a liquid impenetrable back sheet, an acquisition layer, and an absorbent structure, wherein the acquisition layer is disposed beneath the top sheet, and the absorbent structure is located between the acquisition layer and the back sheet.

78. The absorbent article of claim 77, wherein the acquisition layer comprises the cellulosic based acquisition fibers.

79. The absorbent article of claim 77, wherein the absorbent structure comprises a composite of superabsorbent polymer and cellulosic fibers.

80. The absorbent article of claim 79, wherein the superabsorbent polymer is selected from the group consisting of polyacrylate polymers, starch graft copolymers, cellulose graft copolymers, cross-linked carboxymethylcellulose derivatives, and mixtures and combinations thereof.

81. The absorbent article of claim 79, wherein the superabsorbent polymer is in the form of fiber, flakes, or granules.

82. The absorbent article of claim 79, wherein the superabsorbent polymer is present in an amount of from about 20 to about 60% by weight, based on the total weight of the absorbent structure.

83. The absorbent article of claim 79, wherein the cellulosic fiber comprises the cellulosic based acquisition fiber.

84. The absorbent article of claim 79, wherein the cellulosic fiber comprises a mixture of the cellulosic based acquisition fibers and cellulosic fiber.

85. The absorbent article of claim 84, wherein the cellulosic fiber is a wood pulp fiber selected from the group consisting of hardwood pulp, softwood cellulose pulp obtained from a Kraft or sulfite chemical process, mercerized, rayon, cotton linters, and combinations or mixtures thereof.

86. The absorbent article of claim 83, wherein the cellulosic based acquisition fibers are present in an amount of from about 10 to about 80% by weight, based on the total weight of the absorbent structure.

87. The absorbent article of claim 83, wherein the cellulosic based acquisition fibers are present in an amount of from about 20 to about 60% by weight, based on the total weight of the absorbent structure.

88. The absorbent article of claim 83, wherein the cellulosic based acquisition fibers are present in the mixture of fibers in an amount of from about 4 to 40% by weight, based on the total weight of the total fiber.

89. The absorbent article of claim 83, wherein the cellulosic based acquisition fibers are present in the mixture of fibers in an amount of from about 10 to 40% by weight, based on the total weight of the total fiber.

90. The absorbent article of claim 77, wherein the absorbent structure comprises a discrete acquisition layer comprising the cellulosic based acquisition fiber, and a lower absorbent structure; wherein said discrete acquisition layer has a basis weight in the range of 40 to 400 gsm.

91. The absorbent article of claim 90, wherein the discrete acquisition layer extends the full length of the lower absorbent structure.

92. The absorbent article of claim 90, wherein the discrete acquisition layer has a width less than 80% of the lower absorbent structure.

93. The absorbent article of claim 90, wherein the discrete acquisition layer has a length that is 120% to 300% of the length of the lower absorbent structure.

94. The absorbent article of claim 79, wherein the absorbent structure comprises a single-layer absorbent structure that has a surface-rich layer of the cellulosic based acquisition fiber with basis weight in the range of 40 to 400 gsm.

95. The absorbent article of claim 79, wherein the absorbent article comprises a single-layer absorbent structure that has a surface-rich layer of the cellulosic based acquisition fiber where more than 70% of the total acquisition fiber in the absorbent structure resides within the upper 30% of the absorbent structure.

96. The absorbent article of claim 94, wherein the surface-rich layer has an area of about 30% to 70% of the area of the absorbent structure.
